(19) United States
(12) Patent Application Publication
(10) Pub. No.: US 2023/0066091 A1
(43) Pub. Date: Mar. 2, 2023

(54) INTERACTIVE TOUCH CORD WITH MICROINTERACTIONS

(71) Applicant: Google LLC, Mountain View, CA (US)

(72) Inventors: Alex Olwal, Stockholm (SE); Thad Eugene Starner, Atlanta, GA (US)

(21) Appl. No.: 17/796,051

(22) PCT Filed: Jan. 29, 2021
(86) PCT No.: PCT/US2021/015828

§ 371 Date: Jul. 28, 2022

Related U.S. Application Data
(60) Provisional application No. 62/967,527, filed on Jan. 29, 2020.

(51) Int. Cl. G06F 3/01

(52) U.S. Cl. CPC G06F 3/017; G06F 3/011

(57) ABSTRACT

An electronic device includes a touch cord for inputting user commands by hand gesture. The touch cord includes a plurality of conductive sensing lines braided with a plurality of non-conductive lines such that the plurality of conductive sensing lines enable reception of touch inputs that cause a change in capacitance to one or more of the conductive sensing lines. The touch inputs including continuous hand gesture inputs, discrete motion hand gesture inputs, and discrete grasp hand gesture inputs. The electronic device is configured to obtain touch data associated with the touch cord, process the touch data according to one or more trained machine-learned models to identify gesture inputs including continuous hand gesture inputs, discrete motion gesture inputs, and discrete grasp hand gesture inputs. The electronic device can be operated according to one or more user commands associated with the hand gesture inputs.

### FIELD

This application is based on and claims priority to U.S. Provisional Patent Application No. 62/967,527, filed on Jan. 29, 2020 which is hereby incorporated by reference herein in its entirety.

### FIELD

The present disclosure relates generally to interactive objects such as touch cords.

### BACKGROUND

In-line controls for cords are common for devices including earbuds or headphones for music players, cellular phone usage, and so forth. Similar in-line controls are also used by cords for household appliances and lighting, such as clocks, lamps, radios, fans, and so forth. Generally, such in-line controls utilize unfashionable hardware buttons attached to the cord which can break after extended use of the cord. Conventional in-line controls also have problems with intrusion due to sweat and skin, which can lead to corrosion of internal controls and electrical shorts. Further, the hardware design of in-line controls limits the overall expressiveness of the interface, in that increasing the amount of controls requires more hardware, leading to more bulk and cost.

Accordingly, there remains a need for cords that can provide an adequate interface for controlling devices.

### SUMMARY

Aspects and advantages of embodiments of the present disclosure will be set forth in part in the following description, or may be learned from the description, or may be learned through practice of the embodiments.

One example aspect of the present disclosure is directed to an electronic device including a touch cord configured to enable input of user commands by hand gesture. The touch cord includes a plurality of conductive sensing lines braided with a plurality of non-conductive lines. The plurality of conductive sensing lines enable reception of touch inputs that cause a change in capacitance to one or more of the plurality of conductive sensing lines. The touch inputs include continuous hand gesture inputs, discrete motion hand gesture inputs, and discrete grasp hand gesture inputs. The electronic device includes one or more processors configured to obtain touch data associated with the interactive touch cord and process the touch data according to one or more trained machine learned models to identify two or more hand gesture inputs selected from a group the continuous hand gesture inputs, the discrete motion gesture inputs, and the discrete grasp hand gesture inputs. The processor(s) is configured to operate the electronic device according to one or more user commands associated with the two or more hand gesture inputs.

Another example aspect of the present disclosure is directed to a computer-implemented method of managing input of user commands by hand gesture at an interactive touch cord. The method includes obtaining, by one or more processors, touch data associated with the interactive touch cord. The touch cord includes a plurality of conductive sensing lines braided with a plurality of non-conductive lines. The plurality of conductive sensing lines enable reception of touch inputs that cause a change in capacitance to one or more of the plurality of conductive sensing lines. The touch inputs include continuous hand gesture inputs, discrete motion hand gesture inputs, and discrete grasp hand gesture inputs. The method includes processing, by the one or more processors, the touch data according to one or more trained machine learned models to identify two or more hand gesture inputs selected from a group comprising the continuous hand gesture inputs, the discrete motion gesture inputs, and the discrete grasp hand gesture inputs. The method includes operating, by the one or more processors, one or more electronic devices according to one or more user commands associated with the two or more hand gesture inputs.

Yet another example aspect of the present disclosure is directed to one or more non-transitory computer readable media that collectively store instructions that when executed by one or more processors cause the one or more processors to perform operations. The operations include obtaining touch data associated with the interactive touch cord. The touch cord includes a plurality of conductive sensing lines braided with a plurality of non-conductive lines. The plurality of conductive sensing lines enable reception of touch inputs that cause a change in capacitance to one or more of the plurality of conductive sensing lines. The touch inputs include continuous hand gesture inputs, discrete motion hand gesture inputs, and discrete grasp hand gesture inputs. The operations include processing the touch data according to one or more trained machine learned models to identify two or more hand gesture inputs selected from a group comprising the continuous hand gesture inputs, the discrete motion gesture inputs, and the discrete grasp hand gesture inputs. The operations include operating one or more electronic devices according to one or more user commands associated with the two or more hand gesture inputs.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices including touch cords.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system that includes a touch cord integrated in a garment in accordance with example embodiments of the present disclosure;

FIG. 2 depicts a block diagram of an example system that includes a touch cord for an audio playback device in accordance with example embodiments of the present disclosure;

FIG. 3 depicts a block diagram of an example system that includes a touch cord for lamp in accordance with example embodiments of the present disclosure;

FIG. 4 depicts details of a touch cord in accordance with example embodiments of the present disclosure;

FIG. 5 depicts an example of a conductive sensing line in accordance with example embodiments of the present disclosure;

FIG. 6 is a block diagram of an example computing environment that includes an touch cord in accordance with example embodiments of the present disclosure;

FIG. 7 depicts examples of a touch cord in accordance with example embodiments of the present disclosure;

FIG. 8 depicts an example of a touch cord in accordance with example embodiments of the present disclosure;

FIG. 9 depicts an example of user interaction with a touch cord to provide a hand gesture input;

FIG. 10 depicts examples of user interaction with a touch cord to provide hand gesture inputs;

FIG. 11 depicts examples of user interaction with a touch cord to provide hand gesture inputs;

FIG. 12 depicts a graph illustrating the capacitive response of an interactive cord to a set of discrete gesture inputs including discrete motion gesture inputs and discrete grasp gesture inputs in accordance with example embodiments of the present disclosure;

FIG. 13 depicts an interactive cord configured to provide input for an audio playback device in accordance with example embodiments of the present disclosure;

FIG. 14 depicts an interactive cord that is used to provide user commands for a digital magazine in response to continuous and discrete gesture inputs in accordance with example embodiments of the present disclosure;

FIG. 15 is a block diagram depicting an example computing environment, illustrating the detection of gestures by an interactive cord in accordance with example embodiments of the present disclosure;

FIG. 16 depicts a flowchart describing an example method of training a machine-learned model in accordance with example embodiments of the present disclosure;

FIG. 17 depicts a block diagram of an example computing system for training and deploying a machine-learned model in accordance with example embodiments of the present disclosure;

FIG. 18 depicts a block diagram of an example computing device that can be used to implement example embodiments in accordance with the present disclosure; and

FIG. 19 depicts a block diagram of an example computing device that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to an electronic device including a touch cord that includes one or more touch-sensitive areas having conductive sensing lines that are configured to detect user input gestures including microinteractions with the touch cord. More particularly, the touch cord enables reception of touch inputs that include continuous hand gestures as well as discrete hand gestures. The touch cord is configured with a plurality of conductive sensing lines such as conductive threads that are braided or otherwise integrated with a plurality of non-conductive lines such as non-conductive threads. The plurality of sensing lines provide a plurality of capacitive touchpoints at areas where the one or more of the non-conductive threads are surfaced at regular intervals along an outer surface of the touch cord. The sensing lines are configured such that the touch cord can receive and differentiate between continuous hand gestures and discrete hand gestures. An electronic device including the touch cord can process touch data associated with inputs to the touch cord using a machine learning pipeline including one or more machine-learned models. The machine-learned model(s) can identify continuous hand gestures and discrete hand gestures. In this manner, the electronic device enables continuous and discrete gestures to be combined in a single interactive cord to form new, integrated e-textile microinteraction techniques for real-time continuous control, discrete actions, and mode switching.

Integrating capabilities for sensing, feedback and display in everyday objects is part of the vision of both ubiquitous and wearable computing. It is particularly attractive to overcome the boundaries between traditionally rigid devices and soft fabric garments, textiles and furniture to enable technology that can comfortably co-exist with human-facing materials. Recent developments in fabrication, soft electronics and miniaturized computation are leveraged to provide interactive textile concepts and applications.

Many examples exist that leverage textile topologies and electronics to integrate input capabilities. Early commercial efforts, however, focused on adding discrete mechanical or touch-sensitive switches to garments.

With the mass-adoption of multi-touch capacitive sensing in mobile devices, there has been significant attention to how to embed more expressive interaction. Many recent approaches focus primarily on surface patches that enable 2D interaction or 2.5D deformation gestures. These solutions allow absolute 2D positioning and gesture interfaces similar to multi-touch devices, such as phones or tablets. The ability to track fingers enables both mousing and swipes as well as more complex gestures, such as pinch-to-zoom.

However, interfaces that depend on 2D touch surfaces are not always ideal. Wearable and ubiquitous computing allow computation to be more widely integrated with everyday materials such that user interactions can be more casual and eyes-free. Input devices with affordances that match the fast, unambiguous and efficient input with limited attention or effort.

Example embodiments in accordance with the present disclosure advance recent cord-based concepts, hardware and textile interfaces, by enabling the combination of both precise continuous control and casual discrete gestures in a touch cord, also referred to as an interactive touch cord or interactive cord. A braided sensing architecture can be leveraged to enable a series of user studies, which helps the design of suitable casual gestures and a real-time gesture recognition pipeline. To validate the potential for precise interactions, the performance and stability of continuous twisting is evaluated in a controlled study. New capabilities are provided by combining the continuous and discrete gestures into hybrid cord interaction techniques demonstrated in a set of applications.

In accordance with example embodiments of the disclosed technology, an electronic device including an interactive cord can be configured to receive and identify continuous hand gestures and discrete motion gestures. The electronic device can be configured to differentiate or otherwise distinguish between the continuous hand gestures and discrete hand gestures. Continuous hand gesture inputs include continuous motions that enable a continuous user command to be input by a user. An electronic device can associate particular gestures with particular user commands. In some examples, a continuous user command can provide a relative or variable user command to an electronic device. For instance, a user can provide a continuous gesture input that causes the electronic device to initiate a particular functionality in response to a user command associated with the continuous gesture. By contrast, discrete gesture inputs include single-touch or single-movement events that enable discrete user commands to be input by a user. Discrete gesture inputs include single instance touches (also referred to as grasps) or movements that are associated with a single instance of a user command that initiates or triggers a discrete functionality or action.

An electronic device including an interactive cord in accordance with example embodiments of the present disclosure provides e-textile microinteractions that advance cord-based interfaces by enabling the simultaneous use of precise continuous control and casual discrete gestures. A braided sensing line architecture is leveraged to enable a set of continuous and discrete interactions as well as a real-time gesture recognition pipeline. The continuous and discrete gestures can be combined into hybrid cord interaction techniques that can be implemented in a wide range of applications.

According to some aspects, an interactive cord provides a user interface that leverages the unique qualities of capacitive sensing textile cords. Microinteractions are provided that include casual gestures which with minimal attention or effort, and in some cases eyes-free. These gestures enable a user to be able to trigger different basic functionality with one hand. Microinteractions may require less than four seconds to initiate and complete in some examples. They are typically designed to minimize visual, manual and mental attention. This reduced distraction benefits wearable computing and ubiquitous computing, in particular. Cord interfaces are often motivated by their suitability to such non-primary and micro-interaction tasks.

In a similar manner, precise manipulation can be provided as it is desirable to support precise control of at least one continuous parameter in many implementations. Additionally, the described system can leverage affordances. Cord stiffness resists twisting and can provide implicit feedback to the user as to the amount of provided input. An interactive cord in accordance with example embodiments can provide an interface that leverages those tangible characteristics for implicit user feedback.

Continuous gesture inputs include continuous motions that enable a relative or variable user command to be input by a user. For example, a continuous gesture input may control the music volume of an electronic device. A continuous twist gesture input, for example, can be associated with a volume control command whereby a continuous twist of the interactive cord causes a continuous increase/decrease in the volume level.

Discrete gesture inputs can include both single-touch or single-movement events that enable discrete user commands to be input by a user. Discrete gesture inputs include single instance touches (also referred to as grasps) or movements that are associated with a single instance of a user command that initiates or triggers a discrete functionality or action. Discrete grasp gesture inputs include a single touch event of the interactive cord. Discrete grasp gesture inputs may be performed in various ways that can be differentiated. Discrete grasp gesture inputs may include discrete pinch gesture inputs (e.g., performed by a thumb and index finger), discrete grab gesture inputs (e.g., grabbing in a fist), and discrete pat gesture inputs (e.g., tapping with an open hand). Other discrete grasp gestures may include tap gesture inputs.

Discrete motion gesture inputs may include a single movement or motion event of the interactive cord. Discrete motion gesture inputs may include discrete flick gesture inputs and discrete slide gesture inputs. A flick gesture is a quick directional gesture orthogonal to or along the interactive cord. For example, a discrete flick input gesture can be associated with a next/previous track user command for a music or video player. A single instance of the flick gesture input can trigger the player to advance to the next or the previous track/video in a playlist. Various flick gestures may be provided in example embodiments. For instance, a clockwise flick gesture and a counterclockwise flick gesture can be provided. Additionally or alternatively, a flick and hold gesture can be provided. For example, a clockwise flick and hold gesture can be defined by a clockwise orthogonal movement followed by holding the interactive cord for a period of time (e.g., 3 s). A slide gesture is a gesture where a user's hand or fingers move along the length of the cord. Various slide gestures may be provided in example embodiments. For instance, a slide down gesture and a slide up gesture can be provided.

An electronic device in accordance with example embodiments can utilize one or more machine-learned models for gesture recognition of continuous and discrete gesture inputs. A machine-learning pipeline is provided that can expand the expressivity of cord interaction through per-user trained classifiers to allow a broad set of casual gestures to be recognized. In some instances, per-user trained classifiers can be utilized for discrete gesture classification while user-independent classifiers can be utilized for continuous gesture classification. A per-user trained classifier can be provided in example embodiments that is trained based on touch data associated with a particular user. For instance, the electronic device can record touch data associated with a gesture input after prompting a user to perform a particular gesture. The touch data can be annotated to indicate the corresponding gesture. The annotated touch data can be provided as training data to the machine-learned model to train the model on user-specific data. In this manner, a per-user classifier can be generated to classify one or more discrete gesture inputs.

According to some example aspects, an interactive cord provides the ability for parallel sensing of continuous twisting and discrete gestures. This architecture provides new building blocks for interactive applications that can be controlled with a single textile sensor. A continuous twist gesture demonstrates a quantified performance that confirms its suitability for fast and precise control of continuous parameters. Discrete gestures such as flick, pinch, grab, pat and slide can be classified using a machine learning-based pipeline that enables classification of discrete gestures. These discrete gestures can be triggered in parallel with continuous interaction, for use as shortcuts and/or to trigger commands.

An example interactive cord may enable hybrid continuous and discrete gesture interactions. For example, an accelerator gesture can be provided, such as where a flick gesture (discrete) accelerates the effect of a twist gesture (continuous). The flick gesture can be performed as a complementary action to accelerate the effect of continuous twisting. This approach is analogous to touch-screen dragging and swiping to, e.g., transition from smooth scrolling to jumping a page.

In accordance with some example aspects, an electronic device including an interactive cord may enable remapping inputs such as by switching modes. For example, it may be desirable to increase/decrease more than one continuous parameter. In such instances, the electronic device can leverage discrete gestures to cycle across multiple parameters to control. This mechanism also makes it possible to reconfigure the input mapping if it is desirable to change how the interface is controlled (e.g., using discrete instead of continuous control of a parameter).

Systems and methods in accordance with the disclosed technology provide a number of technical effects and benefits. In accordance with example embodiments, hybrid e-textile interaction techniques are provided that combine precise and continuous control with casual and discrete gestures in a compact textile cord interface. In some examples, user-dependent classification of discrete gestures is provided with real-time recognition at high accuracy for multiple gestures. A quantified performance of user-independent continuous twisting for relative input is provided, demonstrating benefits over other input architectures. By way of example, numerous applications can be improved by continuous twist and discrete flick, pinch, grab, pat and slide gestures. These gestures can be used in a cord for microinteractions with devices, digital media, and entertainment. An interactive cord in accordance with example embodiments provides an expressive interface, permitting a user to quickly or slowly twist the cord depending on a target distance of an associated input. Moreover, these actions are easy to reverse.

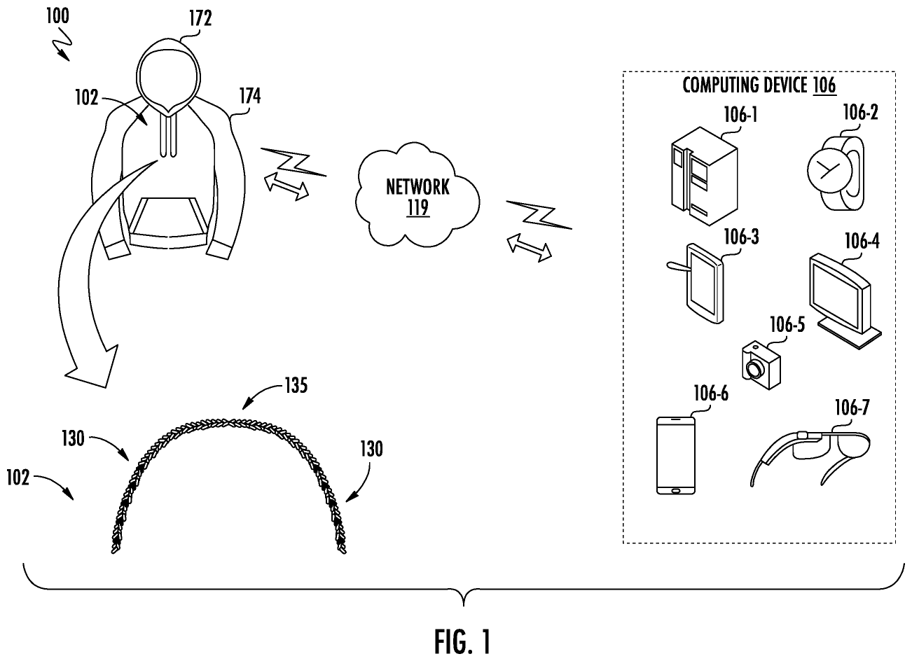

FIG. 1 is an illustration of an example environment 100 in which techniques using, and objects including, an interactive cord in accordance with example embodiments may be implemented. Environment 100 includes an interactive cord 102, which is illustrated as a drawstring for a hoodie or other wearable garment in this particular example. More particularly, interactive cord 102 is formed as a drawstring that extends around a hood 172 of the garment 174. Interactive cord 102 includes one or more touch-sensitive areas 130 including conductive lines configured to detect user input and optionally one or more non-touch-sensitive areas 135 where the conductive lines are configured to not detect touch input due to capacitive sensing. In example computing environment 100, interactive cord 102 includes two touch-sensitive areas 130 and one non-touch-sensitive area 135. It is noted that any number of touch-sensitive areas 130 and/or non-touch-sensitive areas 135 may be included in interactive cord 102. In some examples, the entire interactive cord 102 can be touch sensitive. Interactive cord 102 can include touch-sensitive areas 130 where the interactive cord extends from an enclosure of the hood and can include a non-touch-sensitive area 135 where interactive cord 102 wraps around a neck opening of the hood of the garment. In this manner, inadvertent inputs by contact of the user's neck or other portion of their skin with the interactive cord extending around the neck portion can be avoided.

While interactive cord 102 may be described as a cord or string for a garment or accessory, it is to be noted that interactive cord 102 may be utilized for various different types of uses, such as cords for appliances (e.g., lamps or fans), USB cords, SATA cords, data transfer cords, power cords, headset cords, or any other type of cord. In some examples, interactive cord 102 may be a standalone device. For instance, interactive cord 102 may include a communication interface that permits data indicative of input received at the interactive cord to be transmitted to one or more remote computing endpoints, such as a cellphone, personal computer, or cloud computing device. In some implementations, an interactive cord 102 may be incorporated within an electronic device such as an interactive object. For example, an interactive cord may form the drawstring of a shirt (e.g., hoodie) or pants, shoe laces, etc.

Interactive cord 102 enables a user to control an electronic device such as an interactive object (e.g., garment 174) that the interactive cord 102 is integrated with, or to control a variety of other computing devices 106 via a network 119. Computing devices 106 are illustrated with various non-limiting example devices: server 106-1, smart watch 106-2, tablet 106-3, desktop 106-4, camera 106-5, smart phone 106-6, and computing spectacles 106-7, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers).

Network 119 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Interactive cord 102 can interact with computing devices 106 by transmitting touch data or other sensor data through network 119. Computing device 106 uses the touch data to control computing device 106 or applications at computing device 106. As an example, consider that interactive cord 102 integrated at garment 174 may be configured to control the user's smart phone 106-6 in the user's pocket, desktop 106-4 in the user's home, smart watch 106-2 on the user's wrist, or various other appliances in the user's house, such as thermostats, lights, music, and so forth. For example, the user may be able to swipe up or down on interactive cord 102 integrated within the user's garment 174 to cause the volume on a television to go up or down, to cause the temperature controlled by a thermostat in the user's house to increase or decrease, or to turn on and off lights in the user's house. Note that any type of touch, tap, swipe, hold, or stroke gesture may be recognized by interactive cord 102.

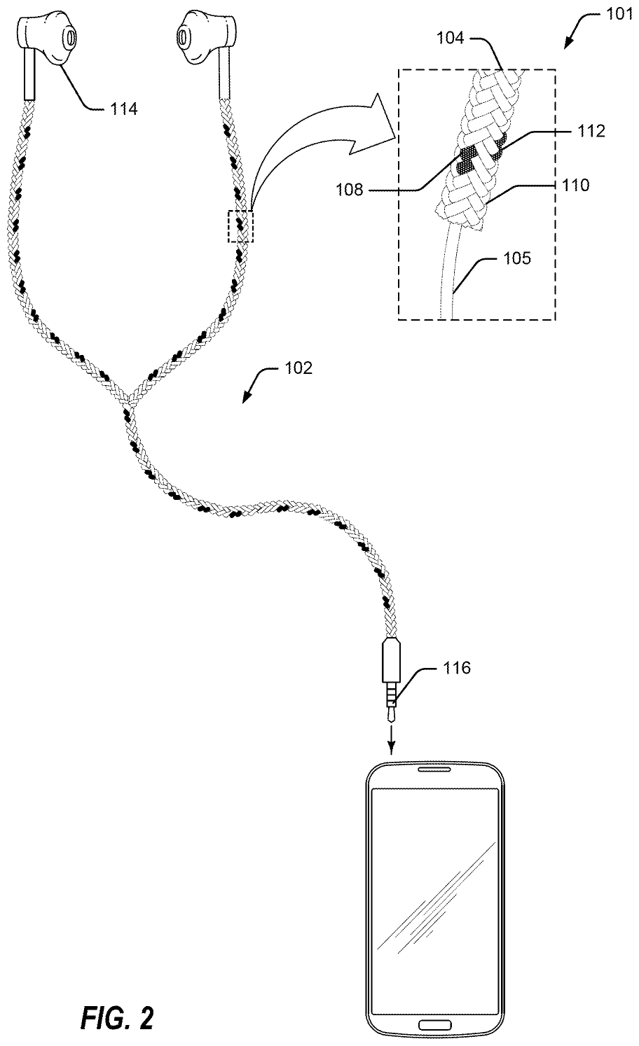

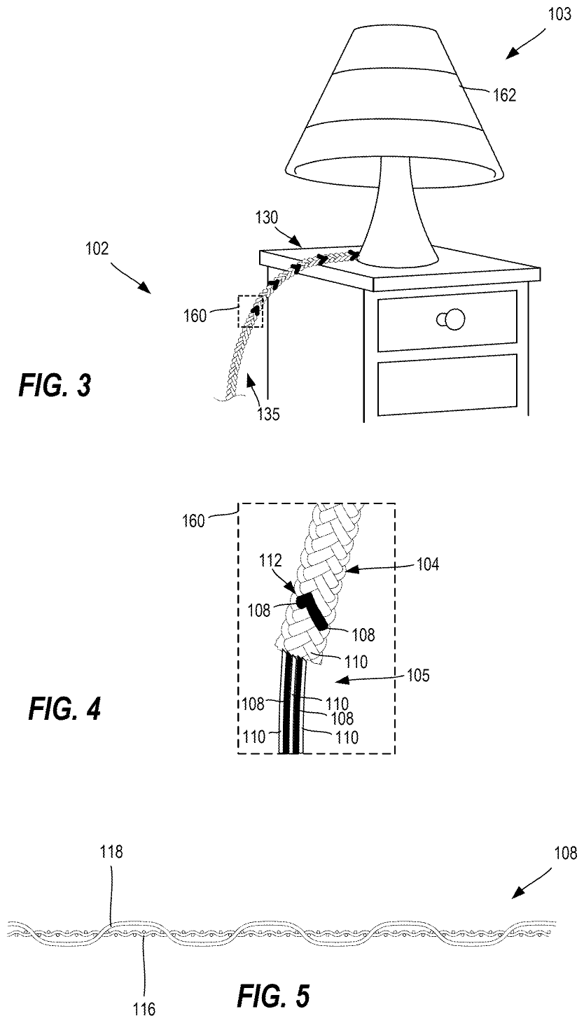

FIG. 2 is an illustration of another example environment 101 in which techniques using, and objects including, an interactive cord may be implemented. Environment 100 includes an interactive cord 102, which is illustrated as a cord for a headset. FIG. 3 illustrates an additional example environment 103 in which interactive cord 102 can be implemented. At environment 103, interactive cord 102 is implemented as a power cord for a lamp 162. In this example, interactive cord 102 may be configured to receive touch input usable to turn on and off the lamp and/or to adjust the brightness of the lamp. In this example, interactive cord includes a single touch-sensitive area 130 in the portion of the interactive cord 102 adjacent to the lamp 162, and a single non-touch-sensitive area 135 extending from the touch-sensitive area 130 to the opposite end portion. In other examples, interactive cord 102 may be configured as a data transfer cord configured to transfer data (e.g., media files) between computing devices 106. Interactive cord 102 may be configured to receive touch input usable to initiate the transfer, or pause the transfer, of data between devices. Interactive cord 102 may include any number of touch-sensitive areas non-touch-sensitive areas.

Interactive cord 102 includes an outer cover 104 surrounding an inner core 105 as shown in the cutaway view of region 160 depicted in FIG. 4. In this example, outer cover 104 is configured to sense touch input using capacitive sensing. To do so, outer cover 104 includes one or more conductive sensing lines 108 that are braided with one or more non-conductive lines 110 to form the outer cover 104. Generally, a conductive sensing line 108 such as a conductive thread corresponds to line that is flexible, but includes a wire that changes capacitance in response to human input. For example, when a finger of a user's hand approaches a conductive thread, the finger causes the capacitance of the conductive thread to change.

To enable outer cover 104 to sense touch input, the outer cover is constructed with one or more capacitive touchpoints 112. Capacitive touchpoints 112 correspond to positions on outer cover 104 that will cause a change in capacitance to conductive sensing line 108 when a user's finger touches, or comes in close contact with, capacitive touchpoint 112. In one or more implementations, the braiding pattern of outer cover 104 exposes conductive sensing line 108 at the capacitive touchpoints 112. In FIG. 3, for example, conductive sensing line 108 is exposed at capacitive touchpoints 112, but is otherwise not visible.

One or more braiding processes can be used to selectively expose the conductive lines at the touch-sensitive area(s) to define capacitive touchpoints 112, while insulating the conductive lines at non-touch-sensitive areas. To facilitate the selective formation of touch-sensitive areas of interactive cord 102, multiple braiding patterns may be applied when forming interactive cord 102 to selectively position sensing lines 108 where touch-sensitive areas are desired.

At a longitudinal portion along a length of the interactive cord forming a touch-sensitive area 130, one or more of the sensing lines 108 are braided with one or more of the non-conductive lines 110 to form a touch-sensitive area. The conductive lines are braided at the first longitudinal portion to define a plurality of capacitive touchpoints 112 where the conductive line or intersections of the conductive lines are exposed at the outer cover 104 of the interactive cord. The interactive cord can include a non-touch-sensitive area 135 where the plurality of conductive lines are inhibited from detecting touch input due to changes in capacitance. For example, the conductive lines can be positioned within the inner core 105 and surrounded by non-conductive lines 110 used to form the outer cover. Additional non-conductive lines 110 may be formed within the inner core 105, for example, to separate one or more of the conductive lines from each other. Although not shown, inner core 105 may include additional wires or cables in some embodiments. For example, a cable configured to communicate audio to a headset may be included within inner core 105 as depicted in FIG. 2. In other examples, a cable within the inner core can be implemented to transfer power, data, or any other electrical signal.

A controller may provide functionality to sense touch input to capacitive touchpoints 112 of interactive cord 102, and to trigger various functions based on the touch input. A remote computing device 106 and/or electronics within the interactive cord or an object the interactive cord is integrated with may include a controller. For example, a controller can be configured to, in response to touch input to capacitive touchpoints 112, start playback of audio to the mobile computing device, pause audio, skip to a new audio file, adjust the volume of the audio, and so forth. In some examples, a controller may include a gesture manager implemented as one or more computer readable instructions. A controller can be implemented at a computing device 106, however, in alternate implementations, a controller may be integrated within interactive cord 102, or implemented with another device, such as powered headphones, a lamp, a clock, and so forth.

FIG. 5 illustrates an example of a conductive sensing line 108 in accordance with one or more embodiments. In this example, conductive sensing line 108 is a conductive thread. The conductive thread includes a conductive wire 118 that is combined with one or more flexible threads 116. Conductive wire 118 may be combined with flexible threads 116 in a variety of different ways, such as by twisting flexible threads 116 with conductive wire 118, wrapping flexible threads 116 with conductive wire 118, braiding or weaving flexible threads 116 to form a cover that covers conductive wire 118, and so forth. Conductive wire 118 may be implemented using a variety of different conductive materials, such as copper, silver, gold, aluminum, or other materials coated with a conductive polymer. Flexible thread 116 may be implemented as any type of flexible thread or fiber, such as cotton, wool, silk, nylon, polyester, and so forth.

Combining conductive wire 118 with flexible thread 116 causes conductive sensing line 108 to be flexible and stretchy, which enables conductive sensing line 108 to be easily woven with one or more non-conductive lines 110 (e.g., cotton, silk, or polyester) to form outer cover 104. Alternately, in at least some implementations, outer cover 104 can be formed using only conductive sensing lines 108.

Other types of conductive sensing lines may be used in accordance with embodiments of the disclosed technology. For example, a conductive sensing line may include one or more optical fibers that can be used to transmit and/or emit light, such as in fiber optic applications. Sensing can be performed using optical coupling between optical fibers woven similarly to conductive threads. Although many examples are provided with respect to conductive threads, it will be appreciated that any type of conductive fiber can be used with an embroidered thread pattern according to example embodiments.

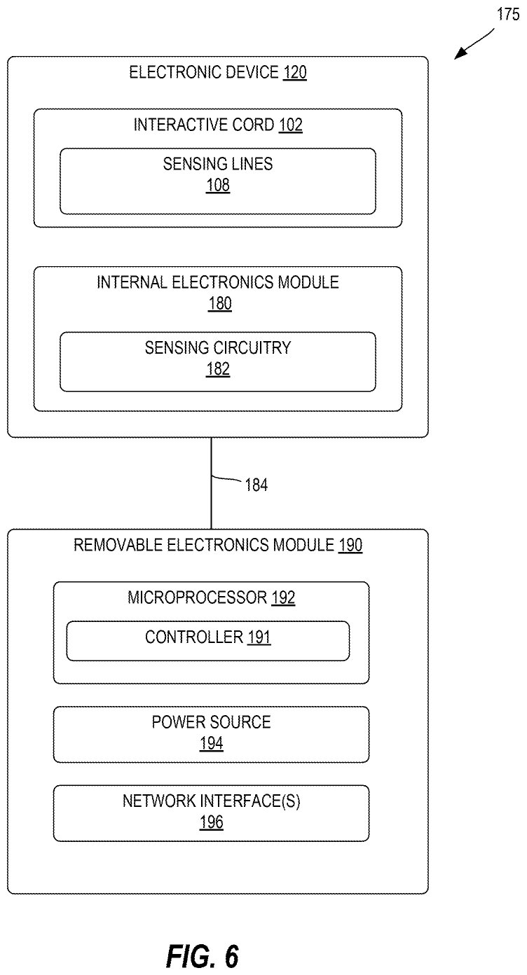

In more detail, consider FIG. 6 which illustrates an example system 175 that includes an interactive cord 102 and multiple electronics modules. In system 175, interactive cord 102 is integrated in or with an electronic device 120, which may be implemented as a flexible object (e.g., shirt, hat, or handbag) or a hard object (e.g., plastic cup or smart phone casing). In yet other examples, interactive cord 102 may itself form the electronic device.

Interactive cord 102 is configured to sense touch-input from a user when one or more fingers of the user's hand touch interactive cord 102 at a touch-sensitive area. Interactive cord 102 may be configured to sense single-touch, multi-touch, and/or full-hand touch-input from a user. To enable the detection of touch-input, interactive cord 102 includes capacitive touchpoints 112, which as described can be formed from one or more conductive lines (e.g., conductive fiber, threads or fiber optic filaments not shown). Notably, the capacitive touchpoints 112 do not alter the flexibility of interactive cord 102 in example embodiments, which enables interactive cord 102 to be easily integrated within electronic devices 120.

Electronic device 120 includes an internal electronics module 180 that is embedded within electronic device 120 and is directly coupled to conductive lines that form capacitive touchpoints 112. Internal electronics module 180 can be communicatively coupled to a removable electronics module 190 via a communication interface 184. Internal electronics module 180 contains a first subset of electronic components for the electronic device 120, and removable electronics module 190 contains a second, different, subset of electronics components for the electronic device 120. As described herein, the internal electronics module 180 may be physically and permanently embedded within the electronic device 120, whereas the removable electronics module 190 may be removably coupled to electronic device 120.

In system 175, the electronic components contained within the internal electronics module 180 include sensing circuity 182 that is coupled to conductive sensing lines 108 that are braided to form interactive cord 102. For example, wires from conductive threads may be connected to sensing circuitry 182 using flexible PCB, creping, gluing with conductive glue, soldering, and so forth. In one embodiment, the sensing circuitry 182 can be configured to detect a user-inputted touch-input on the conductive threads that is pre-programmed to indicate a certain request. The touch-input may then be used to generate touch data usable to control a computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down), and full-hand interactions (e.g., touching the cord with a user's entire hand, covering the cord with the user's entire hand, pressing the textile with the user's entire hand, palm touches, and rolling, twisting, or rotating the user's hand while touching the textile).

Communication interface 184 enables the transfer of power and data (e.g., the touch-input detected by sensing circuity 182) between the internal electronics module 180 and the removable electronics module 190. In some implementations, communication interface 184 may be implemented as a connector that includes a connector plug and a connector receptacle. The connector plug may be implemented at the removable electronics module 190 and is configured to connect to the connector receptacle, which may be implemented at the electronic device 120.

In system 175, the removable electronics module 190 includes a microprocessor 192, power source 194, and network interface 196. Power source 194 may be coupled, via communication interface 184, to sensing circuitry 182 to provide power to sensing circuitry 182 to enable the detection of touch-input and may be implemented as a small battery. In one or more implementations, communication interface 184 is implemented as a connector that is configured to connect removable electronics module 190 to internal electronics module 180 of electronic device 120. When touch-input is detected by sensing circuity 182 of the internal electronics module 180, data representative of the touch-input may be communicated, via communication interface waiting for, to microprocessor 192 of the removable electronics module 190. Microprocessor 192 may then analyze the touch-input data to generate one or more control signals, which may then be communicated to computing device 106 (e.g., a smart phone) via the network interface 196 to cause the computing device 106 to initiate a particular functionality. Microprocessor may execute instructions for a controller 191 that analyzes the touch-input data to generate one or more control signals. Controller 191 may include a gesture manager in example embodiments that is configured to identify one or more gestures from touch data corresponding to a touch input. Generally, network interfaces 196 are configured to communicate data, such as touch data, over wired, wireless, or optical networks to computing devices 106. By way of example and not limitation, network interfaces 216 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through a network).

In example embodiments, the removable electronics module can be removably mounted to a rigid member on the interactive cord or another object (e.g., garment) to which the interactive cord is attached. A connector can include a connecting device for physically and electrically coupling to the removable electronics module. The internal electronics module can be in communication with the connector. The internal electronics module can be configured to communicate with the removable electronics module when connected to the connector. A controller of the removable electronics module can receive information and send commands to the internal electronics module. The communication interface 184 is configured to enable communication between the internal electronics module and the controller when the connector is coupled to the removable electronics module. For example, the communication interface may comprise a network interface integral with the removable electronics module. The removable electronics module can also include a rechargeable power source. The removable electronics module can be removable from the interactive cord for charging the power source. Once the power source is charged, the removable electronics module can then be placed back into the interactive cord and electrically coupled to the connector.

While internal electronics module 180 and removable electronics module 190 are illustrated and described as including specific electronic components, it is to be appreciated that these modules may be configured in a variety of different ways. For example, in some cases, electronic components described as being contained within internal electronics module 180 may be at least partially implemented at the removable electronics module when 90, and vice versa. Furthermore, internal electronics module 180 and removable electronics module when one 90 may include electronic components other that those illustrated in FIG. 4, such as sensors, light sources (e.g., LED's), displays, speakers, and so forth.

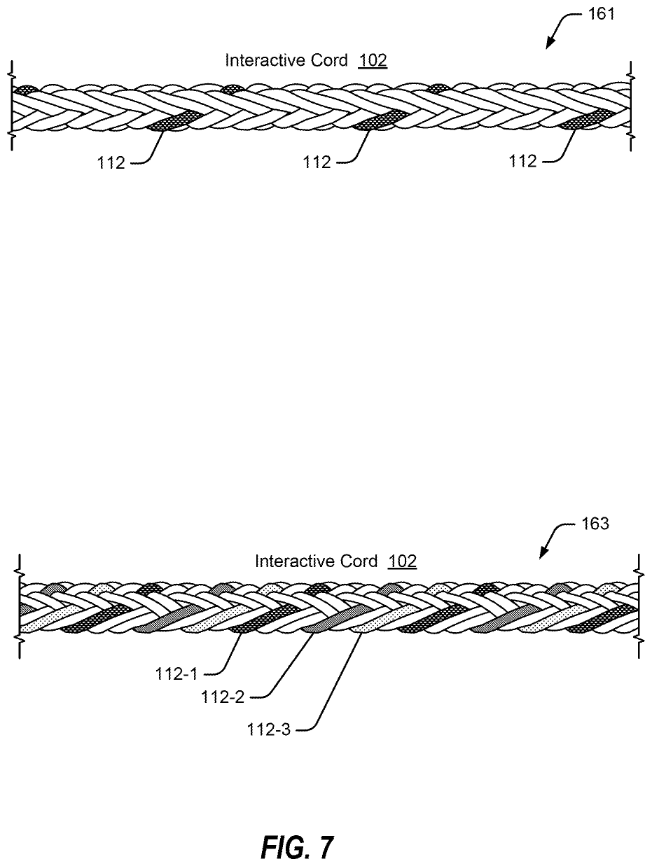

FIG. 7 depicts a more-detailed view of an example of the outer cover of an interactive cord 102 in accordance with example embodiments. Interactive cord 102 may be formed in a variety of different ways. In one or more implementations, the weave pattern of outer cover causes sensing lines 108 to be exposed at capacitive touchpoints 112, but covered and hidden from view at other areas of fabric cover.

In an example depicted at 161, the outer cover includes a single conductive thread, or single set of sensing lines 108, woven with non-conductive lines 110, to form capacitive touchpoints 112. Notably, the one or more sensing lines 108 (e.g., conductive threads) correspond to a first color (black) which is different than a second color (white) of non-conductive lines 110 (e.g., non-conductive threads) woven into the outer cover.

In this example, the weave pattern of the outer cover exposes sensing line 108 at capacitive touchpoints 112 along the outer cover. However, sensing line 108 is covered and hidden from view at other areas of the outer cover. Touch input to any of capacitive touchpoints 112 causes a change in capacitance to sensing line 108, which may be detected by the controller. However, touch input to other areas of the outer cover formed by non-conductive line 110 does not cause a change in capacitance to sensing line 108.

In one or more implementations, the outer cover includes at least a first sensing line 108 and a second sensing line 108. The first sensing line 108 is substantially parallel to the second conductive thread at one or more capacitive touchpoints 112 of the outer cover, but twisted with second sensing line 108 at other areas of the outer cover. Capacitive touchpoints 112 are formed at the areas of the fabric cover at which the first and second conductive threads are parallel to each other because bringing a finger close to capacitive touchpoints 112 will cause a difference in capacitance that can be detected by the controller. However, in the regions where sensing lines 108 are twisted, the closeness of the finger to sensing lines 108 has equal effect on the capacitance of both sensing lines 108, which avoids false triggering if the user touches the sensing line 108. Notably, therefore, sensing line 108 may not need to be covered by non-conductive line 110 in this implementation.

Visual cues can be formed within the fabric cover to provide an indication to the user as to where to touch interactive cord 102 to initiate various functions. In one or more implementations, sensing lines 108 correspond to one or more first colors which are different than one or more second colors of non-conductive lines 110 woven into the outer cover. For example, at 191, the color of sensing line 108 is black, whereas the remainder of the fabric cover is white, which enables the user to recognize where to touch the outer cover 104. Alternately or additionally, the one or more sensing lines 108 can be woven into the outer cover to create one or more tactile capacitive touchpoints by knitting or weaving of the thread to create a tactile cue that can be felt by the user. For example, capacitive touchpoints 112 can be formed to protrude slightly from the outer cover in a way that can be felt by the user when touching interactive cord 102.

In the example outer cover illustrated at 161, the controller is able to detect touch input to the various capacitive touchpoints 112. However, the controller may be unable to distinguish touch input to a first capacitive touchpoint 112 from touch input to a second, different, capacitive touchpoint 112. In this implementation, therefore, the number of functions that can be triggered using interactive cord 102 is limited.

However, capacitive touchpoints 112 that are electrically distinct can be made by incorporating multiple sets of sensing lines 108 into outer cover 104 to create multiple different capacitive touchpoints 112 which can be distinguished by the controller. For example, an outer cover may include one or more first sensing lines 108 and one or more second sensing lines 108. The one or more first sensing lines 108 can be woven into the outer cover such that the one or more first sensing lines 108 are exposed at one or more first capacitive touchpoints 112, and the one or more second sensing lines 108 can be woven into the outer cover such that the one or more second sensing lines 108 are exposed at one or more second capacitive touchpoints 112. Doing so enables a controller to distinguish touch input to the one or more first capacitive touchpoints 112 from touch input to the one or more second capacitive touchpoints 112.

As an example, at 163 the outer cover is illustrated as including multiple electrically distinct capacitive touchpoints 112, which are visually distinguished from each other by using threads of different colors and/or patterns. For example, a first set of conductive thread is colored black with dots to form capacitive touchpoints 112-1, a second set of conductive thread is gray with dots to form capacitive touchpoints 112-2, and a third set of conductive thread is colored white with dots to form capacitive touchpoints 112-3. The weaving pattern of the outer cover surfaces capacitive touchpoints 112-1, 112-2, and 112-3 at regular intervals along the outer cover of interactive cord 102.

In this case, each of the different capacitive touchpoints 112-1, 112-2, and 112-3 may be associated with a different function. For example, the user may be able to touch capacitive touchpoint 112-1 to trigger a first function (e.g., playing or pausing a song), touch capacitive touchpoint 112-2 to trigger a second function (e.g., adjusting the volume of the song), and touch capacitive touchpoint 112-3 to trigger a third function (e.g., skipping to a next song).

Outer cover 104 can be formed using a variety of different weaving or braiding techniques. In example 192, the outer cover 104 is formed by weaving the one or more conductive threads into the outer cover using a loop braiding technique. Doing so causes the one or more capacitive touchpoints to be formed by one or more split loops. In example 192, the outer cover includes 3 different split loops, one for each of the three different types of conductive threads to form capacitive touchpoints 112-1, 112-2, and 112-3. The split loops are placed at particular locations in the pattern to provide isolation between the conductive threads and align them in a particular way. Doing so produces a hollow braid in mixed tabby, and 3/1 twill construction. This gives columns (“wales”) along the length of the braid which exposes lengths of the different fibers. This pattern ensures that each of the sensing lines 108 are in an isolated conductive area, which enables the controller to easily detect which sensing line 108 is being touched, and which is not, at any given time.

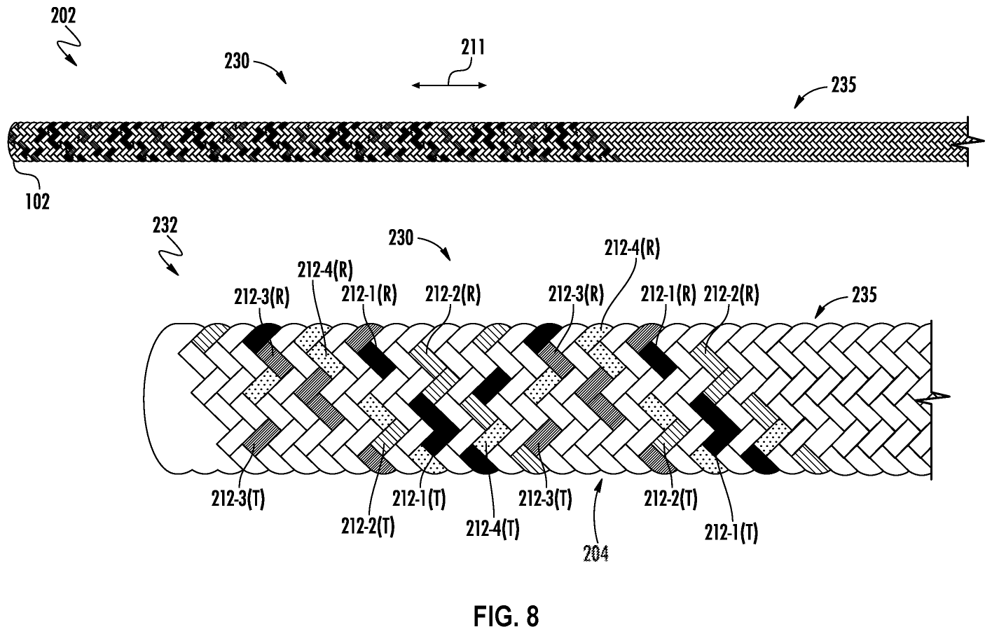

FIG. 8 illustrates another example 202 of an interactive cord 102 in accordance with example embodiments of the present disclosure. In example 202, interactive cord 102 includes a touch-sensitive area 230 adjacent to a non-touch-sensitive area 235. Interactive cord 202 defines a longitudinal direction 211 along its length. Interactive cord 102 includes a plurality of conductive lines implemented as a plurality of conductive threads 212. Interactive cord 102 includes a plurality of non-conductive lines implemented as a plurality of non-conductive threads 210. Conductive threads 212 are selectively braided with the non-conductive threads 210 using two or more thread patterns to selectively define touch-sensitive area 230 for the interactive cord 102. One or more first braiding patterns may be used to form a touch-sensitive area 230 corresponding to a first longitudinal portion of the interactive cord. At the touch-sensitive area 230, conductive threads 212 are selectively exposed at the outer cover 204 of the cord to facilitate the detection of touch input a from capacitive touch points. One or more second braiding patterns can be used to form a non-touch-sensitive area 235 at a second longitudinal portion of the interactive cord 102.

The outer cover 204 may be formed by braiding conductive threads 212 with a first subset of non-conductive threads 210 at the first longitudinal portion of the interactive cord corresponding to the touch-sensitive area 230. The inner core (not shown) of the interactive cord may include a second subset of non-conductive lines at the first longitudinal portion. Optionally, the inner core may also include additional conductive lines that are not exposed at the touch-sensitive area. The second subset of non-conductive lines sensitive may or may not be braided within the inner core at the non-touch-sensitive area. At a second longitudinal portion of the interactive cord corresponding to the non-touch-sensitive area 235, the plurality of conductive threads 212 can be positioned within the inner core such that one or more of the non-conductive threads provide separation to inhibit the conductive threads from detecting touch due to capacitive coupling.

The outer cover at the second longitudinal portion can be formed by braiding the first subset of non-conductive threads and one or more additional non-conductive threads. For instance, one or more of the second subset of non-conductive threads can be routed to the outer cover at the second longitudinal portion and braided with the first subset of the non-conductive threads. In this manner, the interactive cord may include a uniform braiding appearance while using multiple braiding patterns to selectively form touch-sensitive areas. For example, the number of additional non-conductive threads braided with the first subset of non-conductive threads can be equal to the number of conductive threads such that the braiding pattern will appear to be uniform in both the touch-sensitive area 230 and non-touch-sensitive area 235. It is noted that the coloring or pattern of the individual conductive threads shown in FIG. 8 is optional. For example, the conductive threads may be formed with the same color thread as the non-conductive threads such that the interactive cord will have a uniform colored appearance across its entirety.

Within the touch-sensitive area 230, the braiding pattern of outer cover 204 exposes conductive threads 212 at capacitive touchpoints 208 along outer cover 204. Conductive threads 212 are covered and hidden from view at other areas of cover 204 due to the braiding pattern. Touch input to any of capacitive touchpoints 208 causes a change in capacitance to corresponding conductive thread(s) 212, which may be detected by sensing circuitry 182. However, touch input to other areas of outer cover 204 formed by non-conductive threads 210 does not cause a change (or a significant change) in capacitance to conductive threads 212 that is detected as an input. At the non-touch-sensitive area 235, the conductive threads can be formed within the inner core (not shown) such that touch within the non-touch-sensitive area 235 is not registered as an input.

As illustrated in the close-up view 232 of FIG. 8, the plurality of conductive threads 212 can include threads of different types of electrodes that form capacitive sensors that use a mutual capacitance sensing technique. For example, a first group of conductive threads can form transmitter threads 212-1(T), 212-2(T), 212-3(T), and 212-4(T) and a second group of the conductive threads can form receiver threads 212-1(R), 212-2(R), 212-3(R), and 212-4(R). The transmitter threads work as the transmitters of the capacitive sensors, while the receiver threads work as the receivers of the capacitive sensors. The touch sensor can be configured as a grid having rows and columns of conductors that are exposed in the outer cover that the form capacitive touchpoints 208. In a mutual-capacitance sensing technique, the transmitter threads are configured as driving lines, which carry current, and the receiver threads are configured as sensing lines, which detect capacitance at nodes inherently formed in the grid at each intersection.

For example, proximity of an object close to or at the surface of the outer cover 204 that includes capacitive touchpoints 208 may cause a change in a local electrostatic field, which reduces the mutual capacitance at that location. The capacitance change at every individual node on the grid may thus be detected to determine “where” the object is located by measuring the voltage in the other axis. For example, a touch at or near a capacitive touchpoint may cause a detectable change in capacitance at one or more of the transmitter and receiver lines.

In the example of FIG. 8, the outer cover 204 is formed by braiding conductive threads in opposite circumferential directions using so-called “S” threads and “Z” threads. A first group of one or more S threads can be wrapped in a first circumferential direction (e.g., clockwise) around the interactive cord and a second group of one or more Z threads can be wrapped in a second circumferential direction (e.g., counterclockwise) around the interactive cord at a longitudinal portion of the interactive cord including a touch sensor. In this particular example, a set of four S threads are utilized to form the transmitter threads 212-1(T), 212-2(T), 212-3(T), and 212-4(T) and a set of four Z threads are utilized to form the receiver threads 212-1(R), 212-2(R), 212-3(R), and 212-4(R). The S transmitter threads 212-1(T), 212-2(T), 212-3(T), and 212-4(T) are wrapped circumferentially in the clockwise direction. The Z receiver threads 212-1(R), 212-2(R), 212-3(R), and 212-4(R) are wrapped circumferentially in the counterclockwise direction. It is noted that the transmitter threads may be wrapped circumferentially in the counterclockwise direction as Z threads and the receiver threads may be wrapped circumferentially in the clockwise direction as S threads in an alternative embodiment. Moreover, it is noted that the use of four transmitter threads and four receiver threads is provided by way of example only. Any number of conductive threads may be utilized.

The S conductive threads and Z conductive threads cross each other to form capacitive touchpoints 208. In some examples, the equivalent of a touchpad on the outer cover of the interactive cord 102 can be created. A mutual capacitance sensing technique can be used whereby one of the groups of S or Z threads are configured as transmitters of the capacitive sensor while the other group of S or Z threads are configured as receivers of the capacitive sensor. When a user's finger touches or is in proximity to an intersection of a pair of the Z and S threads, the location of the touch can be detected from the mutual capacitance sensor that includes the pair of transmitter and receiver conductive threads. Controller 117 can be configured to detect the location of a touch input in such examples by detecting which transmitter and/or receiver thread is touched. For example, the controller can distinguish a touch to a first transmitter conductive thread (e.g., 212-1(T)) from a touch to a second transmitter conductive thread 212-2(T), third transmitter conductive thread 212-3(T), or a fourth transmitter conductive thread 212-(T). Similarly, the controller can distinguish a touch to a first receiver thread (e.g., 212-1(R)) from a touch to a second receiver thread 212-2(R), third receiver thread 212-3(R), or a fourth receiver thread 212-4(R). In this example, sixteen distinct types of capacitive touch points can be formed based on different pairs of S and Z threads. As will be described hereinafter, a non-repetitive braiding pattern can be used to provide additional detectable inputs in some examples. For example, the braiding pattern can be changed to provide different sequences of capacitive touchpoints that can be detected by the controller 117.

Additionally and/or alternatively, a braiding pattern can be used to expose the conductive threads for attachment to device pins or contact pads for an internal electronics module or other circuitry. For example, a particular braiding pattern may be used that brings the conductive threads to the surface of the interactive cord where the conductive threads can be accessed and attached to various electronics. The conductive threads can be aligned at the surface for easy connectorization.

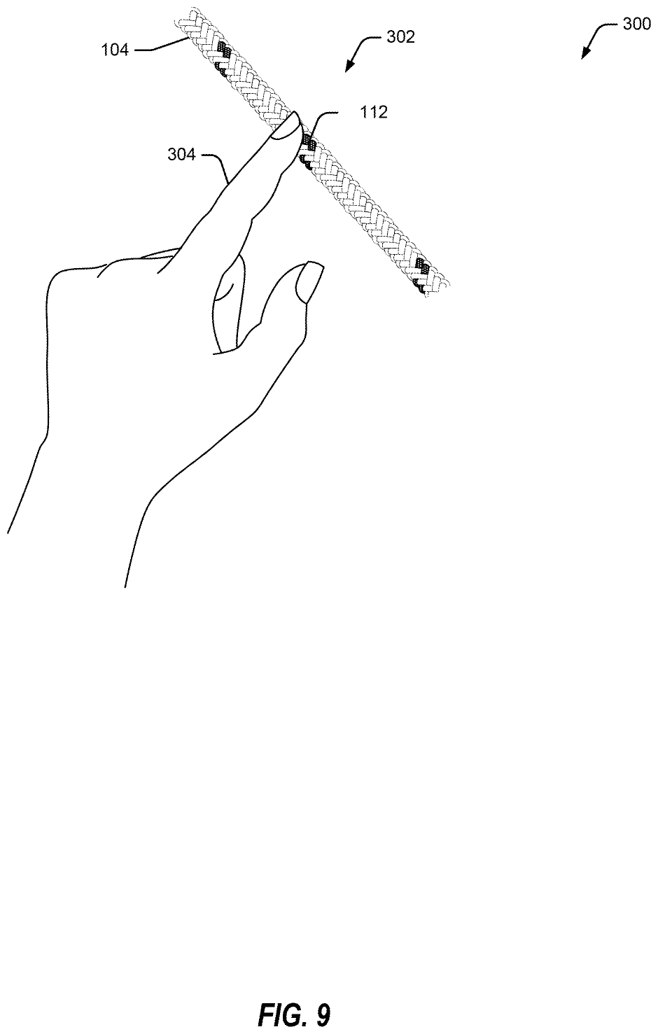

By way of example, consider FIG. 9, which illustrates an example 300 of providing touch input to an interactive cord in accordance with example embodiments. At 302, a finger 304 of a user's hand provides touch input by touching a capacitive touchpoint 112 of outer cover 104 of interactive cord 102. In some cases, the touch input can be provided by moving finger 304 close to capacitive touchpoint 112 without physically touching the capacitive touchpoint.

A variety of different types of touch input 302 may be provided. In one or more implementations, touch input 302 may correspond to a pattern or series of touches to interactive cord 102, such as by touching a first capacitive touchpoint 112 followed by touching a second capacitive touchpoint 112. In one or more implementations, different types of touch input 302 may be provided.

In accordance with example embodiments of the disclosed technology, an electronic device including an interactive cord can be configured to receive and identify continuous hand gesture inputs, discrete motion hand gesture inputs, and discrete grasp hand gesture inputs. The electronic device can be configured to differentiate or otherwise distinguish between the continuous hand gesture inputs, discrete motion hand gesture inputs, and discrete grasp hand gesture inputs.

Continuous gesture inputs include continuous motions that enable a relative or variable user command to be input by a user. For example, a continuous gesture input may control the music volume of an electronic device. A continuous twist gesture input, for example, can be associated with a volume control command whereby a continuous twist of the interactive cord causes a continuous increase/decrease in the volume level.

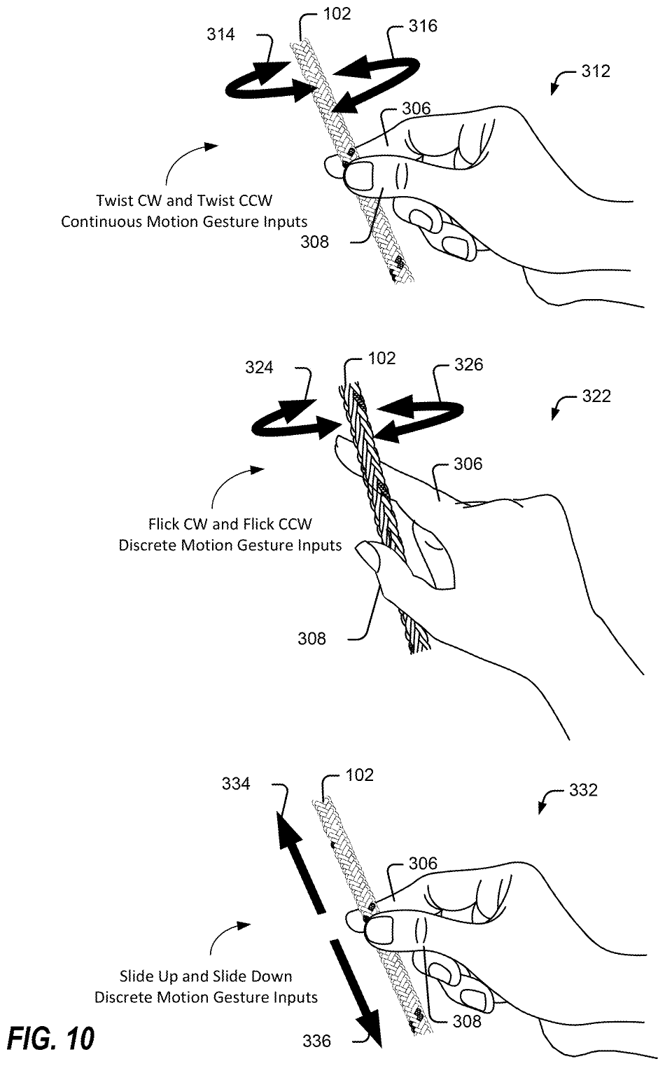

FIG. 10 depicts a continuous twist gesture input at 312. In this example, an index finger 306 and a thumb 308 of the user's hand provides touch input by twisting or rotating interactive cord 102 in their fingers (e.g., by rolling the interactive cord 102 between their thumb and index finger), either clockwise at 314 or counter-clockwise at 316. Electronic device 120 is configured to detect the twist input by detecting a change in one or more capacitance values associated with the sensing lines 108 that are touched by the user's fingers when providing the twist input. For example, the controller can track the phase relationships across the matrix to derive clockwise (CW) or counterclockwise (CCW) twist. The relative motion across the touch matrix is accumulated into a positive or negative angle while the user is gripping or twisting the device. Upon release, the device re-centers at 0 (similar to an elastic joystick) and resets in example embodiments.

Controller 191 may be implemented to detect the direction of the twist input. For example, controller 191 can detect that the twist input corresponds to a first direction (e.g., clockwise in response to the user twisting the cord clockwise as shown at 404). Similarly, controller 191 can detect that the twist input corresponds to twisting or rotating the interactive cord 102 in a second direction that is opposite the first direction (e.g., counter-clockwise in response to the user twisting the interactive cord 102 counter-clockwise as shown at 316). controller 191 may also be able to detect an amount of the twist input (e.g., a partial twist versus a full twist) and/or a speed of the twist input (e.g., a slow twist versus a quick twist).

In contrast to continuous gestures, discrete gesture inputs include single-touch or single-movement events that enable discrete user commands to be input by a user. Discrete gesture inputs include single instance touches (also referred to as grasps) or movements that are associated with a single instance of a user command that initiates or triggers a discrete functionality or action. Discrete grasp gesture inputs include a single touch event of the interactive cord. Discrete grasp gesture inputs may include discrete pinch gesture inputs, discrete grab gesture inputs, and discrete pat gesture inputs. Discrete motion gesture inputs may include a single movement or motion event of the interactive cord. Discrete motion gesture inputs may include discrete flick gesture inputs and discrete slide gesture inputs. For example, a discrete flick input gesture can be associated with a next/previous track user command for a music or video player. A single instance of the flick input gesture can trigger the player to advance to the next or the previous track/video in a playlist.

FIG. 10 depicts a discrete flick gesture input at 322. In this example, an index finger 306 and a thumb 308 of the user's hand provides touch input by providing a directional input orthogonal to the cord. For example, the user's hand may quickly swipe orthogonal to the length of the cord using one or more fingers. In this example, a user moves their index finger and/or thumb orthogonal to the interactive cord to provide either a clockwise flick at 324 or a counter-clockwise flick at 326. Electronic device 120 is configured to detect the flick input by detecting a change in one or more capacitance values associated with the conductive yarns that are touched by the user's fingers when providing flick input. While a continuous twist gesture input includes a continuous twist motion of the interactive cord, a discrete flick gesture input includes a single instance rotation of the cord.

Controller 191 may also be implemented to detect the direction of the flick input. For example, controller 191 can detect that the flick input corresponds to a first direction (e.g., clockwise in response to the user twisting the cord clockwise as shown at 324). Similarly, gesture manager 193 can detect that the flick input corresponds to motion in a second direction that is opposite the first direction (e.g., counter-clockwise in response to the user flicking the interactive cord 102 counter-clockwise as shown at 326).

FIG. 10 depicts a discrete slide gesture input at 332. In this example, an index finger 306 and a thumb 308 of the user's hand provides touch input by providing a directional input along the cord. For example, the user's hand may quickly swipe down or up the cord using one or more fingers. In this example, a user moves their index finger and/or thumb along (parallel) to the interactive cord to provide either an upward slide gesture input 334 or a downward slide gesture input 336. Electronic device 120 is configured to detect the slide gesture input by detecting a change in one or more capacitance values associated with the sensing lines 108 that are touched by the user's fingers when providing slide input.

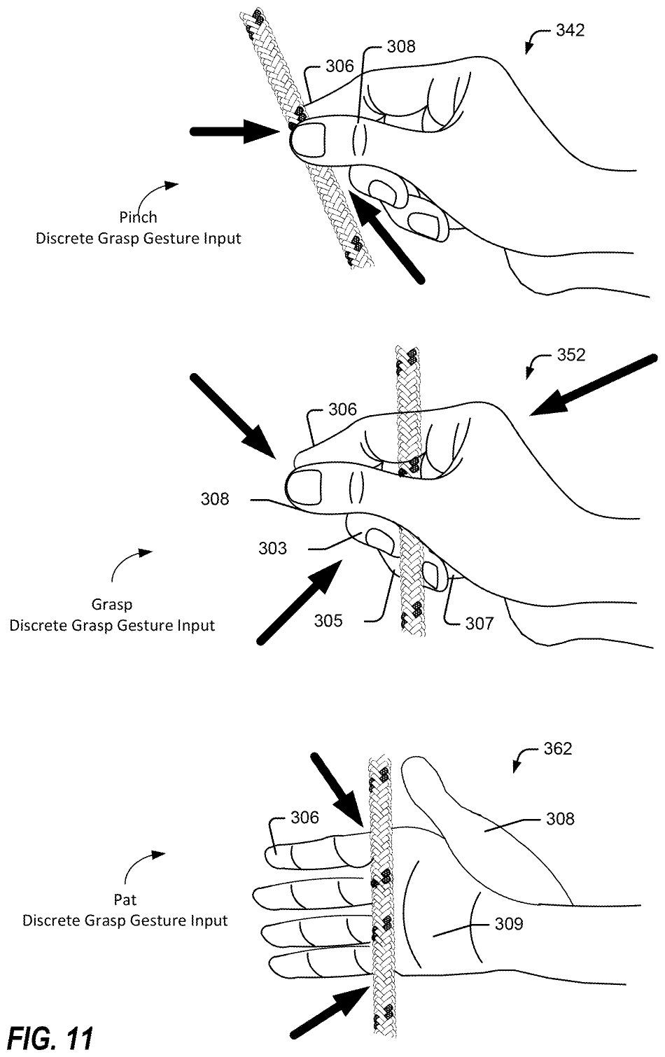

FIG. 11 depicts a set of discrete grasp (also referred to as discrete touch) gesture inputs. A discrete pinch gesture input is depicted at 342. In this example, an index finger 306 and a thumb 308 of the user's hand provides touch input by providing opposing inputs at opposite portions along the circumference of the interactive cord surface. As an example, an index finger 306 and a thumb 308 of the user's hand can provide touch input by pinching a one or more capacitive touchpoints 112 of the interactive cord. It is noted that a pinch input gesture can be differentiated or otherwise distinguished from a simple touch or tap gesture to provided to the interactive cord. Providing a pinch input gesture may trigger a function that is different than a function triggered by simply touching or tapping a capacitive touchpoint 112.

A discrete grab gesture input is depicted at 352. In this example, a user's hand provides touch input by grabbing or grasping the interactive cord in a fist or fist-shaped manner. As an example, an index finger 306, middle finger 303, ring finger 305, pinkie finger 307, and thumb 308 of the user's hand can provide touch input by grasping one or more capacitive touchpoints 112 of the interactive cord. It is noted that a grasp input may include less than all of the fingers of a user's hand touching the interactive cord. In example embodiments, a grab input gesture can be differentiated or otherwise distinguished from a pinch gesture due to the capacitance profile associated with the sensing elements during the grab gesture.

A discrete pat gesture input is depicted at 362. In this example, a user's hand provides a pat gesture input by tapping the interactive cord with an open hand. The open-handed touch can be contrasted with the close-handed touch associated with the grab gesture. As an example, a user's palm can provide touch input by touching or coming close to the interactive cord while in an open position. In another example, the back of a user's hand can provide a pat gesture input. In example embodiments, a pat gesture input can be differentiated or otherwise distinguished from a grab gesture input due to the capacitance profile associated with the sensing elements during the pat gesture input.

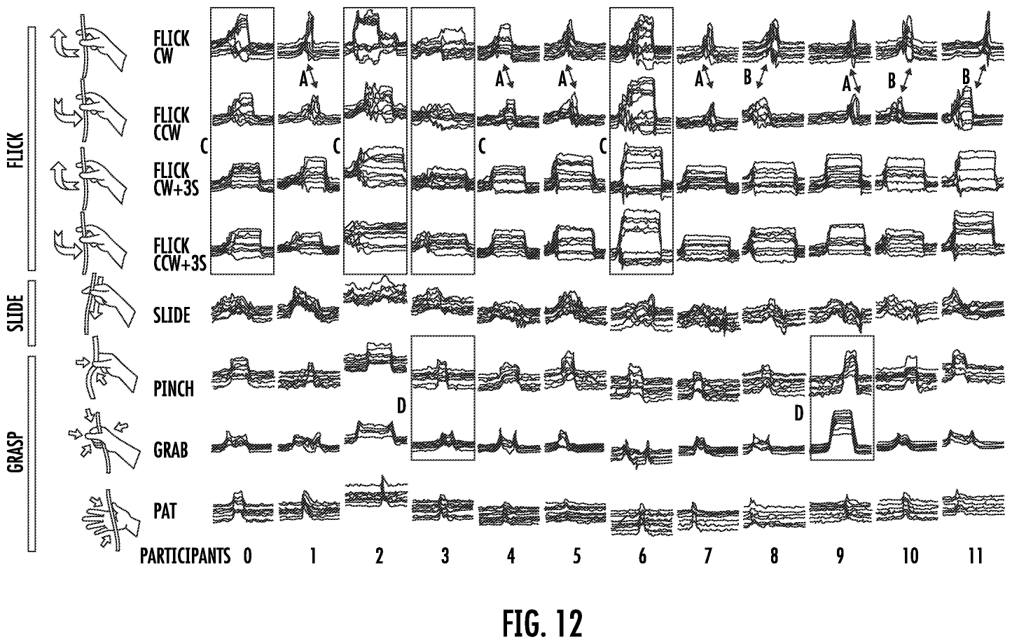

FIG. 12 depicts a graph depicting the capacitive response of an interactive cord to a set of discrete gesture inputs including discrete motion gesture inputs and discrete grasp gesture inputs in accordance with example embodiments of the present disclosure. Four flick gestures are depicted including a clockwise flick gesture, a counterclockwise flick gesture, a clockwise flick gesture plus a 3 s hold, and a counterclockwise flick gesture plus a 3 s hold. A single slide gesture is depicted. Three grasp gestures are depicted including a pinch gesture, a grab gesture, and a pat gesture. For each gesture input, the capacitive response of the interactive cord for a group of users is illustrated. The data was gathered through interaction with an interactive cord by a group of 13 participants. Participants performed 10 repetitions for the eight discrete gestures. The first repetition was removed from analysis and classification. An interactive cord system was used which provides 16 integer values from a 4×4 repeating capacitive sensing matrices along the braided textile cord. In this particular example, a braid that was ˜500 mm long with ø4 mm.

For each gesture set, an experimenter demonstrated the gesture and let the participant practice. When ready, the experimenter started the data collection for that gesture. Participants made contact with the cord and performed the gesture. Immediately after completion, they released the cord.

In this particular example, 16 raw capacitance values along with metadata (e.g., participant #, gesture type, repetition #and time stamps) were recorded. In this manner, 8 gestures×9 repetitions×12 participants were used to provide 864 samples for analysis.

The plot shows data from one repetition (out of nine) for the 12 participants (horizontal axis) for the eight gestures (vertical axis). Each sub-image shows a plot of 16 overlaid feature vectors, which has been interpolated to 80 observations over time. Participants performed gestures without feedback and in their own style, such that user-dependent classification was used in example embodiments.

It can be seen that (A/B) Temporal variations between Flick directions differ between participant group A and B. For group (C) Flick vs. Flick→hold 3 s was potentially less distinguishable for some participants, compared to group A/B. For group (D), the capacitive response associated with some participants were very similar for Pinch and Grab gestures. In example embodiments, a machine-learned model can be trained to differentiate or otherwise identify the various gestures based on the differing capacitive responses to the corresponding touch.

In accordance with example embodiments, a Python-based toolchain using machine learning for time series analysis and classification can be used. Sample length can vary according to the time to perform the gesture in a repetition. Each gesture time series can be resampled with linear interpolation. FIG. 12 shows 96 samples (12 participants×8 gestures) with each having 16 features linearly interpolated to 80 observations over time.

In example embodiments, a machine-learned gesture recognition model is provided that can identify or otherwise recognize a set of continuous gesture inputs and/or discrete motion inputs. By way of example, a machine-learned gesture recognition model for discrete motion inputs can receive touch data (e.g., sensor data or data derived from sensor data) and provide a sorted list of gestures with classification probabilities. In an example, the machine-learned model pipeline can be trained for a subset of an original gesture set, to focus on a subset of gestures (e.g., flick (CW/CCW), slide down, pinch and grab). A 9-fold leave-one-sample-out cross-validation for each of the 12 participants in the experiment resulted in a high average accuracy for the subset (e.g., greater than 95%). The pipeline operates in real-time and in parallel with continuous twist and touch tracking. A set of Java applications can be implemented to explore how the new interaction techniques of continuous and discrete gestures could enable different expressivity for the user.

Based on the data set size and characteristics, a time-series specific support vector classifier can be used with a global alignment kernel using various implementations. A 9-fold leave-one-repetition-out cross-validation for each user across the gestures can be used in some examples. For example, the model can be trained on 8 repetitions and tested on 1 repetition×9 permutations. Other techniques can be used.

Example experiments indicate a high average recognition accuracy. These experiments demonstrate that a low-resolution sensor matrix (e.g., eight electrodes) can enable additional gestural expressivity and demonstrate robustness beyond traditional gesture recognition. Notable here is that there are inherent relationships in the repeated sensing matrices that are well-suited for machine learning classification. The support vector classifier enables quick training with limited data, which makes a user-dependent interaction system reasonable. Training for a typical gesture may have a completion time comparable to the amount of time required to train a fingerprint sensor.

In accordance with example embodiments, user-independent classification can be used. Referring again to the experiment, participants were allowed to freely perform the eight gestures in their own style without feedback so as to accommodate individual differences since the classification of grasps may be highly dependent on user style (“contact”), preference (“how to pinch/grab”) and anatomy (e.g., hand size).

Embodiments in accordance with the present disclosure provide a gesture pipeline designed to provide user-dependent training. In some examples, this technique may result in more consistency within each user's data, but various differences across participants.

In some instances, differences between users can result in low accuracy in leave-one-user-out cross validation analysis. In some examples, users can be clustered into similar groups which are then used to create independent per-group recognizers. Real-time feedback can also help mitigate differences as the user generally learns to adjust their behavior to achieve better results.

In example embodiments, user-dependent classification can be used. For instance, an interactive cord may provide a setup phase whereby a machine-learned model can be trained for a particular user of the interactive cord. For instance, the interactive cord may communicate with a computing device such as a smartphone executing an application associated with the interactive cord. The application may prompt a user to perform a particular gesture input. The sensor data collected during performance of the particular gesture input by the user can be used to train one or more machine-learned models. The sensor data may be annotated with an indication of the particular gesture input. The training data for the particular user can be provided to the machine-learned model to generate a user-dependent machine-learned classifier.

In accordance with some example embodiments, an interactive cord may provide a per-user trained gesture recognition model which can enable multiple new discrete gestures. Eight discrete gestures can be provided in example embodiments although more or fewer gestures can be provided. Such a model illustrates how a variety of actions can be triggered from the interactive cord. In some examples for continuous interactions, however, the interactive cord may provide user-independent, continuous twist or other gesture input recognition models that can enable performance of precision tasks, such as controlling music volume.

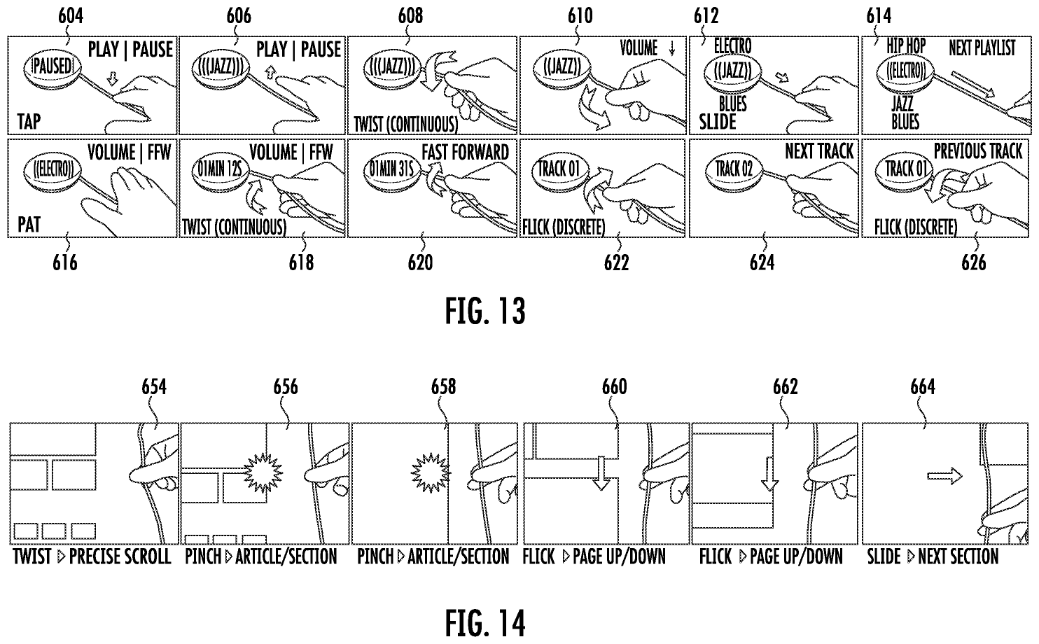

An interactive cord as described can enable a range of possible applications. FIG. 13 depicts an example implementation of an interactive cord in accordance with example embodiments of the present disclosure. FIG. 13 depicts an interactive cord configured to provide input for an audio playback device. The interactive cord augments continuous motion gesture inputs with discrete motion gesture inputs and discrete grasp gesture inputs to provide an interactive speaker cord. By way of example, the interactive speaker cord may augment an existing power or audio cable with interactive gestures for quick and casual control. For instance, pinch (or tap) may be used for play/pause and grab or pat to toggle between controlling volume or playback position. Continuous twist thus allows smoothly changing the volume or fastforwarding the track. A quick flick changes to the next/previous track, while slide advances to the next playlist.

As shown at 604 and 606, a tap gesture input is associated with the user input commands “play” and “pause.” A controller of the interactive cord or audio playback device can recognize a tap gesture input, determine that it is associated with a play/pause input command, and initiate a functionality for the play/pause command (starting or pausing playback of an audio track) by the audio playback device.

As shown at 608, 610, and 618 a continuous twist gesture input is associated with a user input command for device volume. The controller determines that a continuous counterclockwise twist gesture input as shown at 608 is associated with a user command to decrease volume. The controller can initiate a functionality associated with the “decrease volume” user command as shown at 610. A continued twist in the counterclockwise direction results in a continued decrease in the volume.

As shown at 616, a pat gesture input is provided to toggle between modes. In a first mode, the continuous twist input gestures are associated with volume as earlier described. A clockwise twist gesture input is associated with a user command to increase the volume as shown at 618. The controller can respond to clockwise twist gesture by increasing the volume in accordance with the “increase volume” user command. In this manner, the continuous gesture input enables a variable user command function. An amount of the twist can be correlated with an amount of the volume increase/decrease. The system can determine an amount of a twist input and determine a corresponding amount of a user command function based on the amount of twist input.

By providing a pat gesture, a user can switch the interactive cord to a second mode as shown at 620. In the second mode, the continuous twist input gestures are associated with fast-forward and rewind user commands. As shown at 622 in the second mode, the controller determines that a clockwise gesture is performed and in response initiates the fast-forward command functionality to advance to the next track.

As shown at 612 and 614, a slide gesture input is associated with the user input commands “next playlist” and “previous playlist.” In response to determining that a down slide input gesture is performed as shown at 612, the controller determines that the next playlist user command is to be initiated. The controller can initiate the next playlist functionality to advance to the next playlist for the device. In response to determining that a slide up gesture is performed as shown at 614, the controller initiates the previous playlist functionality to advance to the previous playlist for the device.

As shown at 622, 624, and 626, discrete flick gesture inputs are associated with a “next track” and “previous track” user command. In response to determining that a clockwise flick input 622 is performed, the controller determines that the next track user command is to be initiated. The controller can initiate the next track user command functionality to advance to the next track in a playlist, as shown at 624 for example. In response to a counterclockwise flick input as shown at 626, the controller initiates the previous track command functionality to advance to the previous track in a playlist.

FIG. 14 depicts an interactive cord that is used to provide user commands for a digital magazine in response to continuous and discrete gesture inputs. The interactive cord augments continuous motion gesture inputs with discrete motion gesture inputs and discrete grasp gesture inputs to provide various user commands through the interactive cord interface. The smooth continuous twist gesture can be leveraged in a manner analogous to a jog dial to scroll up or down with varying speeds. A flick can be implemented as an accelerator for page down or up. Similar to how touch-screen interfaces use drag and swipe, this interaction combines fine manipulation, rate control, and acceleration in a single mode. Further, the user can pinch the cord to toggle between a list of articles and to focus on a specific article. The slide gesture cycles to the next magazine section. Such an interface may be used for reading on a mobile device while wearing headphones. It allows the reader to control the essentials of a reading experience without having to touch the display.

As shown at 654, a continuous twist gesture input is associated with a user command for precise scrolling. In response to determining that a continuous clockwise twist gesture input is performed, the controller can initiate a functionality associated with the user command for scrolling. A continued twist in the clockwise direction results in a continued scroll of the magazine content. In response to determining that a continuous counterclockwise twist gesture input is performed, the controller can initiate scrolling in a reverse direction.

A discrete pinch gesture input is depicted at 656 and 658. The discrete pinch gesture input is associated with an article and/or section enter/exit user command. In response to a discrete pinch gesture input, the controller can initiate the functionality to enter or exit a selected article.

A discrete flick gesture input is depicted at 660 and 662. The discrete pinch gesture input is associated with page up/page down user command. In response to a discrete flick gesture input, the controller can initiate the functionality to move up or down in a page of the content. In some examples, a clockwise flick can be associated with a page up user command to initiate such functionality and a counterclockwise flick can be associated with a page down user command to initiate such functionality.

A discrete slide gesture input is depicted at 664. The discrete slide gesture input is associated with a next section user command. In response to a discrete slide gesture input, the controller can initiate the functionality to move to a next or previous section in content. In some examples, slide up gesture input can be associated with a next section user command to initiate such functionality and a slide down gesture can be associated with a previous section user command to initiate such functionality.

It is noted that the association of particular user commands with particular gesture inputs is provided by way of example only.

As described with respect to FIG. 14, a particular gesture may be used to toggle between modes of the electronic device. Other gestures may be associated with different user commands or otherwise initiate different functionalities based on the mode of the electronic device. Consider an experience that requires time sensitive interactive control such as a video game (e.g., Tetris). Two modes can be defined in which the user can alternate between using the grab gesture. In a first mode (e.g., twist mode), continuous twists move blocks or objects in a user interface left/right, and pinch rotates the block. In a second mode (e.g., flick mode), discrete flicks move left/right, pinch rotates the block, and slide down drops the block. This example demonstrates two strategies that the user can toggle between effortlessly. The more sensitive continuous twist is faster, but may have risks of overshooting. The discrete flick gestures require more effort but provide more consistent control.

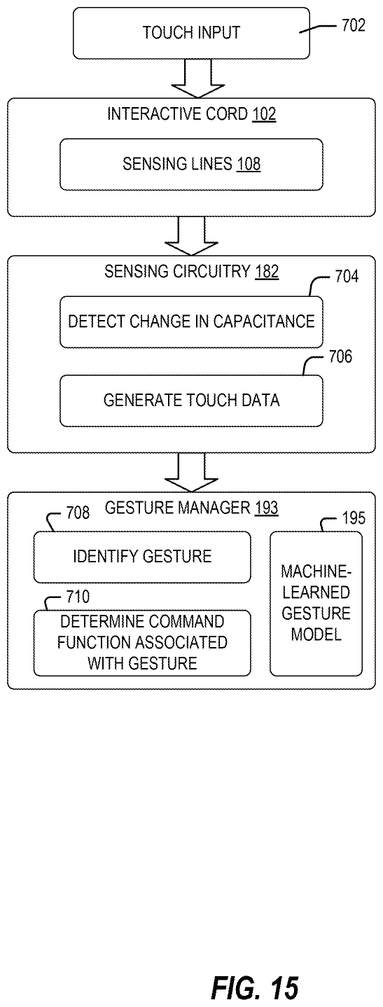

FIG. 15 is a block diagram depicting an example computing environment including an interactive cord in communication with sensing circuitry 182 and gesture manager 193. As earlier described, sensing circuitry 182 may be part of internal electronics module 180 in example embodiments. Gesture manager 193 may be implemented at removable electronics module 190 in example embodiments. Gesture manager 193 may be implemented partially or wholly by other components, such as by internal electronics module 180 and/or a remote computing device such as a smartphone for example. Gesture manager 193 may be implemented as part of controller 191 in example embodiments.

An electronic device including an interactive cord 102 and/or one or more computing devices in communication with interactive cord 102 can detect a user gesture based at least in part on sensing lines 108 of the interactive cord 102. For example, electronic device 120 and/or the one or more computing devices can implement a gesture manager 193 that can identify one or more gestures in response to touch input 702 to the interactive cord 102.

Interactive cord 102 can detect a touch input 702 based on a change in capacitance associated with a set of conductive sensing lines 108. For example, a user can move an object (e.g., finger, conductive stylus, etc.) proximate to or touch interactive cord 102, causing a response by the individual sensing elements. By way of example, the capacitance associated with each sensing element can change when an object touches or comes in proximity to the sensing element. As shown at (704), sensing circuitry 126 can detect a change in capacitance associated with one or more of the sensing elements. Sensing circuitry 126 can generate touch data at (706) that is indicative of the response (e.g., change in capacitance) of the sensing elements to the touch input. The touch data can include one or more touch input features associated with touch input 702. In some examples, the touch data may identify a particular element, and an associated response such as a change in capacitance. In some examples, the touch data may indicate a time associated with an element response.

Gesture manager 193 can analyze the touch data to identify the one or more touch input features associated with touch input 702. Gesture manager 193 can be implemented at electronic device 120 (e.g., by one or more processors of internal electronics module 124 and/or removable electronics module 206) and/or one or more computing devices remote from the electronic device 120.

At (710), gesture manager 193 can determine a gesture based at least in part on the touch data. In some examples, gesture manager 193 can identify at least one gesture based on reference data. Reference data can include data indicative of one or more predefined parameters associated with a particular input gesture. The reference data can be stored in a reference database in association with data indicative of one or more gestures. Reference database can be stored at electronic device 120 (e.g., internal electronics module 124 and/or removable electronics module 206) and/or at one or more remote computing devices in communication with the electronic device 120. In such a case, electronic device 120 can access reference database via one or more communication interfaces (e.g., network interface 216).

Gesture manager 193 can compare the touch data indicative of the touch input 702 with reference data corresponding to at least one gesture. For example, gesture manager 193 can compare touch input features associated with touch input 702 to reference data indicative of one or more pre-defined parameters associated with a gesture. Gesture manager 193 can determine a correspondence between at least one touch input feature and at least one parameter. Gesture manager 193 can detect a correspondence between touch input 702 and at least one line gesture identified in reference database based on the determined correspondence between at least one touch input feature and at least one parameter. For example, a similarity between the touch input 702 and a respective gesture can be determined based on a correspondence of touch input features and gesture parameters.

In some examples, gesture manager 193 can input touch data into one or more machine learned gesture classification models 195. A machine-learned gesture classification model 195 can be configured to output a detection of at least one gesture based on touch data associated with a touch input. Machine learned gesture classification model 195 can generate an output including data indicative of a gesture detection. For example, machine learned gesture classification model 195 can be trained, via one or more machine learning techniques, using training data to detect particular gestures based on touch data.

Gesture manager 193 can input touch data indicative of touch input 702 into machine learned gesture classification model 195. One or more gesture classification models 195 can be configured to generate one or more outputs indicative of whether the touch data corresponds to one or more input gestures. Gesture classification model 195 can output data indicative of a particular gesture associated with the touch data. Gesture classification model 195 can be configured to output data indicative of an inference or detection of a respective gesture based on a similarity between touch data indicative of touch input 702 and one or more parameters associated with the gesture.

Electronic device 120 and/or a remote computing device in communication with electronic device 120 can initiate one or more actions based on a detected gesture. For example, the detected gesture can be associated with a navigation command (e.g., scrolling up/down/side, flipping a page, etc.) in one or more user interfaces coupled to electronic device 104 (e.g., via the interactive cord 102, the controller, or both) and/or any of the one or more remote computing devices. In addition, or alternatively, the respective gesture can initiate one or more predefined actions utilizing one or more computing devices, such as, for example, dialing a number, sending a text message, playing a sound recording etc.

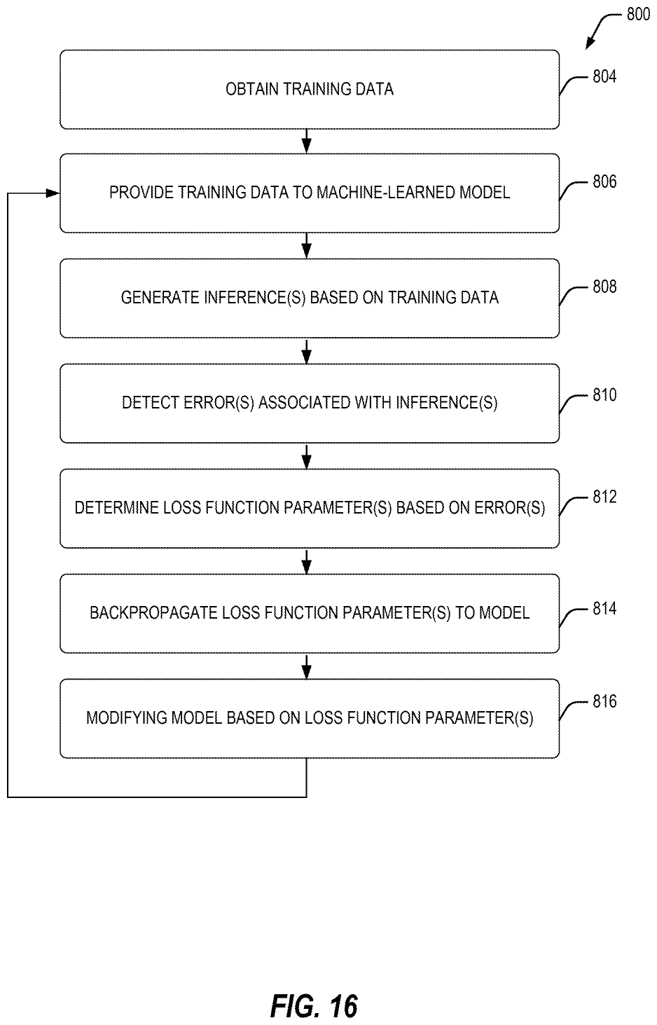

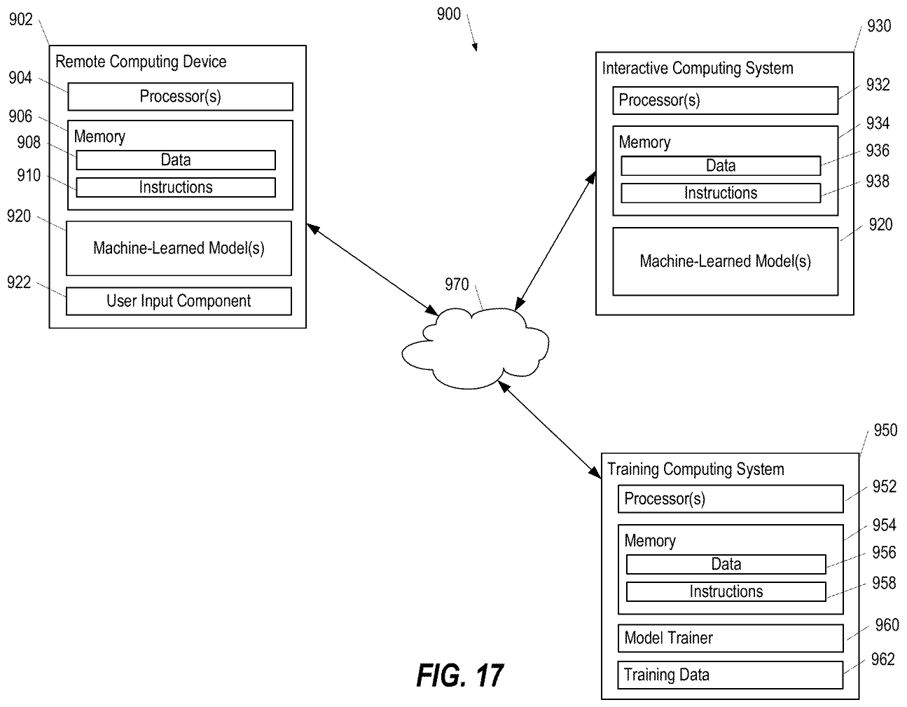

FIG. 16 is a flowchart depicting an example method 800 of training a machine-learned model that is configured to identify gesture inputs for an interactive cord. The model can be trained to generate inferences of gesture inputs based on touch data such as sensor data generated by the interactive cord. One or more portions of method 800 can be implemented by one or more computing devices such as, for example, one or more computing devices of a computing environment as illustrated herein. One or more portions of method 800 can be implemented as an algorithm on the hardware components of the devices described herein to, for example, train a machine-learned model to process sensor data, generate feature representations, and generate inferences of gesture inputs. In example embodiments, method 800 may be performed by a model trainer 1060 using training data 1062 as illustrated in FIG. 17.

At (802), training data for training the machine-learned model is obtained. In some examples, the training data may include or otherwise be based on sensor data associated with a group of users in order to generate a user-independent gesture recognition model. In other examples, the training data may be associated with a particular user in order to generate a user-dependent gesture recognition model. For instance, an electronic device including an interactive cord may prompt a user of the interactive cord to perform a particular gesture and record the sensor data associated with the user performing the particular gesture. The sensor data can be annotated with an indication of the particular gesture to generate training data for the particular gesture and the particular user. The model can be trained on such user-specific training data to generate a user-dependent gesture recognition model.

At (806), training data is provided to the machine-learned gesture recognition model. The training data may include sensor data and/or feature representation data. The sensor data and/or feature representation data may have been annotated to indicate n gesture input associated with the corresponding sensor data and/or feature representation data. For instance, the data may be annotated to indicate a gesture or movement represented by the sensor data or feature representation data.

At (808), one or more inferences such as indications of particular gestures determined to correspond to particular training data are generated by the model. For instance, in response to sensor data corresponding to a particular touch input, an inference may be generated indicating a gesture corresponding to the sensor data.

At (810), one or more errors are detected in association with the inference(s). For example, the model trainer may detect an error with respect to a generated inference, such as that a determined gesture from the sensor data does not match the label or annotation indicating the actual gesture corresponding to the sensor data.

At (812), one or more loss function parameters can be determined for the model based on the detected errors. In some examples, the loss function parameters can be based on an overall output of the model. In some examples, a loss function parameter may include a sub-gradient. A sub-gradient can be calculated for the model or some portion thereof based on the detected error.

At (814), the one or more loss function parameters are back propagated to the model. For example, a sub-gradient calculated for the model can be back propagated to the model.

At (816) one or more portions of the machine-learned model can be modified based on the backpropagation at 814. In some examples, the machine-learned model may be modified based on backpropagation of the loss function parameter.

FIG. 17 depicts a block diagram of an example computing environment 900 that can be used to implement any type of computing device as described herein. The system environment includes a remote computing system 902, an interactive computing system 930, and a training computing system 940 that are communicatively coupled over a network 970. The interactive computing system 930 can be used to implement an electronic device including an interactive cord in some examples.

The remote computing system 902 can include any type of computing device, such as, for example, a personal computing device (e.g., laptop or desktop), a mobile computing device (e.g., smartphone or tablet), a gaming console or controller, an embedded computing device, a server computing device, or any other type of computing device.

The remote computing system 902 includes one or more processors 904 and a memory 906. The one or more processors 904 can be any suitable processing device (e.g., a processor core, a microprocessor, an ASIC, a FPGA, a controller, a microcontroller, etc.) and can be one processor or a plurality of processors that are operatively connected. The memory 906 can include one or more non-transitory computer-readable storage mediums, such as RAM, ROM, EEPROM, EPROM, flash memory devices, magnetic disks, etc., and combinations thereof. The memory 906 can store data 908 and instructions 910 which are executed by the processor 904 to cause the remote computing system 902 to perform operations.

The remote computing system 902 can include one or more machine-learned models 920 such as a continuous gesture input classification model, a discrete gesture input classification model or a combination model capable of classification of both gesture types.

The remote computing system 902 can also include one or more input devices (not shown) that can be configured to receive user input. By way of example, the one or more input devices can include one or more soft buttons, hard buttons, microphones, scanners, cameras, etc. configured to receive data from a user of the remote computing system 902. For example, the one or more input devices can serve to implement a virtual keyboard and/or a virtual number pad. Other example user input devices include a microphone, a traditional keyboard, or other means by which a user can provide user input.

The remote computing system 902 can also include one or more output devices (not shown) that can be configured to provide data to one or more users. By way of example, the one or more output device(s) can include a user interface configured to display data to a user of the remote computing system 902. Other example output device(s) include one or more visual, tactile, and/or audio devices configured to provide information to a user of the remote computing system 902.

The interactive computing system 930 can be used to implement any type of interactive object such as, for example, a wearable computing device. The interactive computing system 930 includes one or more processors 932 and a memory 934. The one or more processors 632 can be any suitable processing device (e.g., a processor core, a microprocessor, an ASIC, a FPGA, a controller, a microcontroller, etc.) and can be one processor or a plurality of processors that are operatively connected. The memory 693434 can include one or more non-transitory computer-readable storage mediums, such as RAM, ROM, EEPROM, EPROM, flash memory devices, magnetic disks, etc., and combinations thereof The memory 934 can store data 936 and instructions 938 which are executed by the processor 932 to cause the interactive computing system 930 to perform operations. The interactive computing system 9930 can include one or more machine-learned models 920 such as a continuous gesture input classification model, a discrete gesture input classification model or a combination model capable of classification of both gesture types.

The interactive computing system 930 can also include one or more input devices that can be configured to receive user input. For example, the user input device can be a touch-sensitive component (e.g., an interactive cord 102) that is sensitive to the touch of a user input object (e.g., a finger or a stylus). As another example, the user input device can be an inertial component (e.g., inertial measurement unit) that is sensitive to the movement of a user. Other example user input components include a microphone, a traditional keyboard, or other means by which a user can provide user input. The interactive computing system 930 can also include one or more output devices configured to provide data to a user. For example, the one or more output devices can include one or more visual, tactile, and/or audio devices configured to provide the information to a user of the interactive computing system 930.

The training computing system 950 includes one or more processors 952 and a memory 944. The one or more processors 952 can be any suitable processing device (e.g., a processor core, a microprocessor, an ASIC, a FPGA, a controller, a microcontroller, etc.) and can be one processor or a plurality of processors that are operatively connected. The memory 944 can include one or more non-transitory computer-readable storage mediums, such as RAM, ROM, EEPROM, EPROM, flash memory devices, magnetic disks, etc., and combinations thereof. The memory 954 can store data 956 and instructions 958 which are executed by the processor 952 to cause the training computing system 950 to perform operations. In some implementations, the training computing system 950 includes or is otherwise implemented by one or more server computing devices.

The training computing system 940 can include a model trainer 960 that trains a one or more machine-learned classification model(s) 920 using various training or learning techniques, such as, for example, backwards propagation of errors. In other examples as described herein, training computing system 950 can train a machine-learned classification model 920 using training data 962. For example, the training data 962 can include labeled sensor data generated by interactive computing system 930. The training computing system 940 can receive the training data 962 from the interactive computing system 930, via network 970, and store the training data 962 at training computing system 940. The machine-learned classification model 920 can be stored at training computing system 940 for training and then deployed to remote computing system 902 and/or the interactive computing system 930. In some implementations, performing backwards propagation of errors can include performing truncated backpropagation through time. The model trainer 960 can perform a number of generalization techniques (e.g., weight decays, dropouts, etc.) to improve the generalization capability of the classification model 920.

In particular, the training data 962 can include a plurality of instances of sensor data, where each instance of sensor data has been labeled with ground truth inferences such as one or more predefined movement recognitions. For example, the label(s) for each instance of sensor data can describe the position and/or movement (e.g., velocity or acceleration) of an object movement. In some implementations, the labels can be manually applied to the training data by humans. In some implementations, the machine-learned classification model 920 can be trained using a loss function that measures a difference between a predicted inference and a ground-truth inference.

The model trainer 960 includes computer logic utilized to provide desired functionality. The model trainer 960 can be implemented in hardware, firmware, and/or software controlling a general purpose processor. For example, in some implementations, the model trainer 960 includes program files stored on a storage device, loaded into a memory and executed by one or more processors. In other implementations, the model trainer 960 includes one or more sets of computer-executable instructions that are stored in a tangible computer-readable storage medium such as RAM hard disk or optical or magnetic media.

In some examples, a training database can be stored in memory on an interactive object, removable electronics module, user device, and/or a remote computing device. For example, in some embodiments, a training database can be stored on one or more remote computing devices such as one or more remote servers. The machine-learned classification model 920 can be trained based on the training data in the training database. For example, the machine-learned classification model 920 can be learned using various training or learning techniques, such as, for example, backwards propagation of errors based on the training data from training database.

In this manner, the machine-learned classification model 920 can be trained to determine at least one of a plurality of predefined movement(s) associated with the interactive object based on movement data.

The machine-learned classification model 920 can be trained, via one or more machine learning techniques using training data. For example, the training data can include movement data previously collected by one or more interactive objects. By way of example, one or more interactive objects can generate sensor data based on one or more movements associated with the one or more interactive objects. The previously generated sensor data can be labeled to identify at least one predefined movement associated with the touch and/or the inertial input corresponding to the sensor data. The resulting training data 1062 can be collected and stored in a training database.

The network 970 can be any type of communications network, such as a local area network (e.g., intranet), wide area network (e.g., Internet), or some combination thereof and can include any number of wired or wireless links. In general, communication over the network 970 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 16 illustrates one example computing system that can be used to implement the present disclosure. Other computing systems can be used as well. For example, in some implementations, the remote computing system 902 can include the model trainer 960 and the training data 962. In such implementations, the classification model 920 can be trained and used locally at the remote computing system 902. In some of such implementations, the remote computing system 902 can implement the model trainer 960 to personalize the classification model 920 based on user-specific movements.

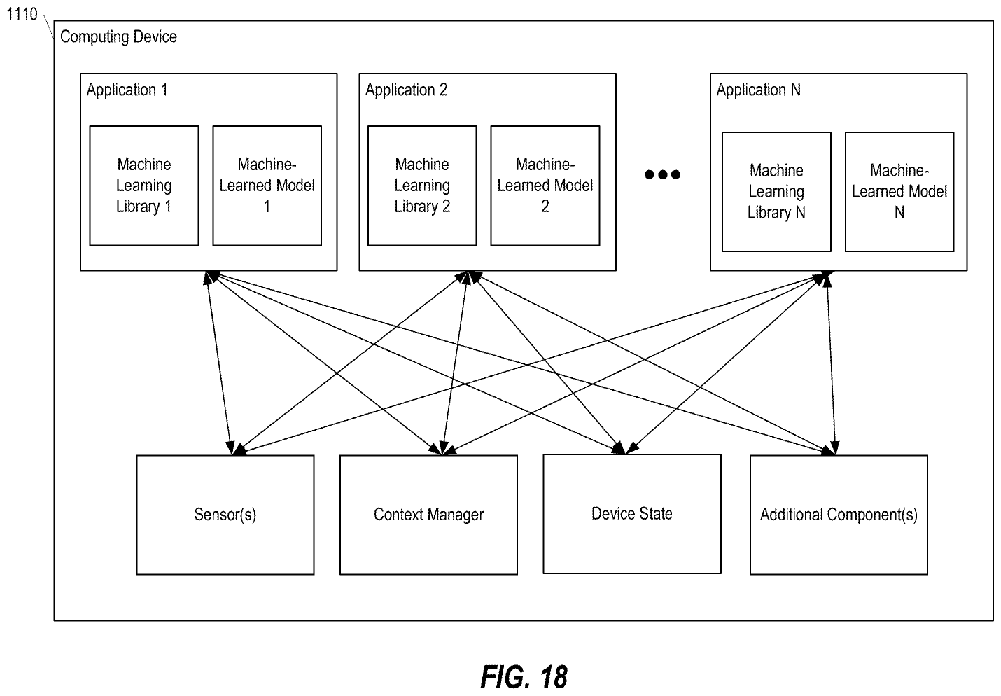

FIG. 18 depicts a block diagram of an example computing device 1110 that performs according to example embodiments of the present disclosure. The computing device 1110 can be a user computing device or a server computing device.

The computing device 1110 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 18, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

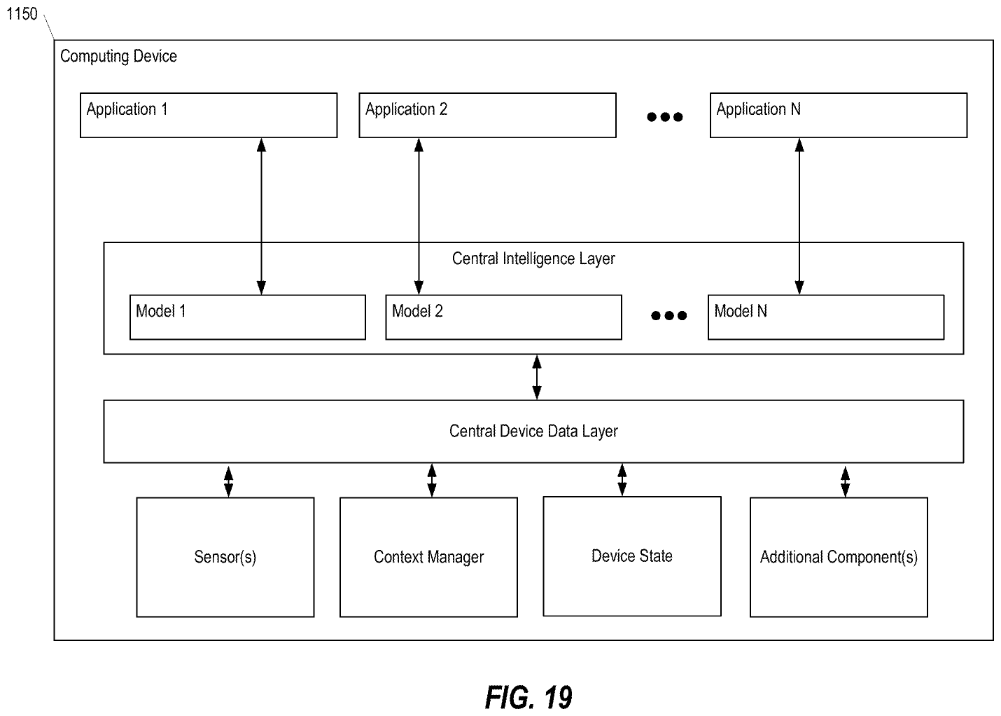

FIG. 19 depicts a block diagram of an example computing device 1150 that performs according to example embodiments of the present disclosure. The computing device 1150 can be a user computing device or a server computing device.

The computing device 1150 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 19, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1150.

The central intelligence layer can communicate with a central device data layer. The central device data layer can be a centralized repository of data for the computing device 1150. As illustrated in FIG. 12, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. An electronic device comprising:
a touch cord configured to enable input of user commands by hand gesture, the touch cord comprising a plurality of conductive sensing lines braided with a plurality of non-conductive lines, the plurality of conductive sensing lines enable reception of touch inputs that cause a change in capacitance to one or more of the plurality of conductive sensing lines, the touch inputs including continuous hand gesture inputs, discrete motion hand gesture inputs, and discrete grasp hand gesture inputs; and
one or more processors configured to:
obtain touch data associated with the touch cord;
process said touch data according to one or more machine-learned models to identify two or more hand gesture inputs selected from a group comprising the continuous hand gesture inputs, the discrete motion hand gesture inputs, and the discrete grasp hand gesture inputs; and
operate the electronic device according to one or more user commands associated with the two or more hand gesture inputs.

2. The electronic device of claim 1, wherein:
the touch cord is a capacitive touch cord.

3. The electronic device of claim 1, wherein:
the continuous hand gesture inputs include twist input gestures;
the discrete motion hand gesture inputs include a flick gesture input and a slide gesture input; and
the discrete grasp hand gesture inputs include a pinch gesture input, a grab gesture input, and a pat gesture input.

4. The electronic device of claim 1, wherein:
the continuous hand gesture inputs include a clockwise twist gesture input and a counterclockwise twist gesture input; and
the one or more processors are configured to:
process the clockwise twist gesture input to determine a first variable user command and to process the counterclockwise twist gesture input to determine a second variable user command;
determine an amount of the clockwise twist gesture input and a corresponding amount of the first variable user command based on the amount of the clockwise twist gesture input; and
determine an amount of the counterclockwise twist gesture input and a corresponding amount of the second variable user command based on the amount of the counterclockwise twist gesture input.

5. The electronic device of claim 4, wherein:
the discrete motion hand gesture inputs include a clockwise flick gesture input and a counterclockwise flick gesture input;
the one or more processors are configured to:
process the clockwise flick gesture input to determine a first discrete command and to process the counterclockwise twist gesture input to determine a second discrete command;
initiate a single instance of the first discrete command in response to the clockwise flick gesture input; and
initiate a single instance of the second discrete command in response to a single instance of the counterclockwise flick gesture input.

6. The electronic device of claim 1, wherein said two or more hand gesture inputs comprise a first hand gesture input and a second hand gesture input, the one or more processors are configured to:
receive a third hand gesture input prior to receiving said two or more hand gesture inputs;
determine a first mode or a second mode of the electronic device based on the third hand gesture input;
wherein operating the electronic device comprises operating the electronic device according to a first user command when the electronic device is in the first mode and operating the electronic device according to a second user command when the electronic device is in the second mode.

7. The electronic device of claim 1, wherein the one or more processors are configured to:
generate training data for the one or more machine-learned models in response to touch data generated in response to a plurality of touch inputs received from a particular user of the touch cord; and
train the one or more machine-learned models based on the training data by determining one or more parameters of a loss function based on the training data and modifying at least a portion of the one or more machine-learned models based at least in part on the one or more parameters of the loss function.

8. The electronic device of claim 1, wherein one or more machine-learned models include:
a user-independent machine-learned classification model configured to identify the continuous hand gesture inputs; and
a user-dependent machine-learned classification model configured to identify at least one of the discrete motion hand gesture inputs and the discrete graph hand gesture inputs.

9. The electronic device of claim 1, wherein:
said two or more hand gesture inputs comprise a first continuous hand gesture input and at least one of a first discrete motion hand gesture input or a first discrete grasp hand gesture input; and
the one or more processors are configured to process said touch data indicative of the first continuous hand gesture input and the at least one of the first discrete motion hand gesture input or the first discrete grasp hand gesture input to determine a first user command based on both the first continuous hand gesture input and the at least one of the first discrete motion hand gesture input or the first discrete grasp hand gesture input.

10. The electronic device of claim 1, wherein:
the plurality of conductive sensing lines are braided with the plurality of non-conductive lines to form a plurality of capacitive touchpoints.

11. The electronic device of claim 10, wherein:
the plurality of conductive sensing lines form a weave pattern that surfaces the plurality of capacitive touchpoints at regular intervals along an outer surface of the touch cord.

12. The electronic device of claim 1, wherein:
the change in capacitance to the one or more of the plurality of conductive sensing lines in response to the continuous hand gesture inputs is differentiable from the change in capacitance to the one or more of the plurality of conductive sensing lines in response to the discrete grasp hand gesture inputs and from the change in capacitance to the one or more of the plurality of conductive sensing lines in response to the discrete motion hand gesture inputs.

13. The electronic device of claim 1, wherein:
the plurality of conductive sensing lines includes transmitter conductive threads and receiver conductive threads;
the transmitter conductive threads are braided in a first circumferential direction around the touch cord; and
the receiver conductive threads are braided in a second circumferential direction around the touch cord.

14. A computer-implemented method of managing input of user commands by hand gesture at a touch cord, the method comprising:
obtaining, by one or more processors, touch data associated with the touch cord, the touch cord comprising a plurality of conductive sensing lines braided with a plurality of non-conductive lines, the plurality of conductive sensing lines enable reception of touch inputs that cause a change in capacitance to one or more of the plurality of conductive sensing lines, the touch inputs including continuous hand gesture inputs, discrete motion hand gesture inputs, and discrete grasp hand gesture inputs;
processing, by the one or more processors, said touch data according to one or more machine-learned models to identify two or more hand gesture inputs selected from a group comprising the continuous hand gesture inputs, the discrete motion hand gesture inputs, and the discrete grasp hand gesture inputs; and
operating, by the one or more processors, one or more electronic devices according to one or more user commands associated with the two or more hand gesture inputs.

15. The computer-implemented method of claim 14, wherein:
the continuous hand gesture inputs include a clockwise twist gesture input and a counterclockwise twist gesture input; and
the method further comprises:
processing the clockwise twist gesture input to determine a first variable user command and processing the counterclockwise twist gesture input to determine a second variable user command;
determining an amount of the clockwise twist gesture input and a corresponding amount of the first variable user command based on the amount of the clockwise twist gesture input; and
determining an amount of the counterclockwise twist gesture input and a corresponding amount of the second variable user command based on the amount of the counterclockwise twist gesture input.

16. The computer-implemented method of claim 15, wherein:
the discrete motion hand gesture inputs include a clockwise flick gesture input and a counterclockwise flick gesture input;
the method further comprises:
processing the clockwise flick gesture input to determine a first discrete command and processing the counterclockwise twist gesture input to determine a second discrete command;
initiating a single instance of the first discrete command in response to the clockwise flick gesture input; and
initiating a single instance of the second discrete command in response to a single instance of the counterclockwise flick gesture input.

17. The computer-implemented method of claim 14, wherein said two or more hand gesture inputs comprise a first hand gesture input and a second hand gesture input, the method further comprising:
receiving a third hand gesture input prior to receiving said two or more hand gesture inputs;
determining a first mode or a second mode of the one or more electronic devices based on the third hand gesture input;
wherein operating the one or more electronic devices comprises operating the one or more electronic devices according to a first user command when the one or more electronic devices are in the first mode and operating the one or more electronic devices according to a second user command when the one or more electronic devices are in the second mode.

18. The computer-implemented method of claim 14, further comprising:
generating training data for the one or more machine-learned models in response to touch data generated in response to a plurality of touch inputs received from a particular user of the touch cord; and
training the one or more machine-learned models based on the training data by determining one or more parameters of a loss function based on the training data and modifying at least a portion of the one or more machine-learned models based at least in part on the one or more parameters of the loss function.

19. One or more non-transitory computer readable media that collectively store instructions that when executed by one or more processors cause the one or more processors to perform operations, the operations comprising:
obtaining touch data associated with an interactive touch cord comprising a plurality of conductive sensing lines braided with a plurality of non-conductive lines, the plurality of conductive sensing lines enable reception of touch inputs that cause a change in capacitance to one or more of the plurality of conductive sensing lines, the touch inputs including continuous hand gesture inputs, discrete motion hand gesture inputs, and discrete grasp hand gesture inputs;
processing said touch data according to one or more trained machine learned models to identify two or more hand gesture inputs selected from a group comprising said continuous hand gesture inputs, said discrete motion hand gesture inputs, and said discrete grasp hand gesture inputs; and
operating one or more electronic devices according to one or more user commands associated with the two or more hand gesture inputs.

20. The one or more non-transitory computer readable media of claim 19, wherein:
the continuous hand gesture inputs include a clockwise twist gesture input and a counterclockwise twist gesture input; and
the operations further comprise:
processing the clockwise twist gesture input to determine a first variable user command and processing the counterclockwise twist gesture input to determine a second variable user command;
determining an amount of the clockwise twist gesture input and a corresponding amount of the first variable user command based on the amount of the clockwise twist gesture input; and
determining an amount of the counterclockwise twist gesture input and a corresponding amount of the second variable user command based on the amount of the counterclockwise twist gesture input.
